(19) United States
(12) Patent Application Publication
(10) Pub. No.: US 2004/0042400 A1
(43) Pub. Date: Mar. 4, 2004

(54) Connection admission control based on bandwidth and buffer usage

(75) Inventors: Dan Horlin, Enskede (SE); Lars-Goran Petersen, Tumba (SE)

Correspondence Address: NIXON & VANDERHYE, PC, 1100 N GLEBE ROAD, 8TH FLOOR, ARLINGTON, VA, 22201-4714, US

(73) Assignee: Telefonaktiebolaget LM Ericsson, Stockholm (SE)

(21) Appl. No.: 10/629,773

(22) Filed: Jul. 30, 2003

Related U.S. Application Data
(62) Division of application No. 09/365,826, filed on Aug. 3, 1999.

(30) Foreign Application Priority Data
Dec. 18, 1998 (WO) PCT/IB98/02072

(51) Int. Cl. H04L 1/00

(52) U.S. Cl. 370/232; 370/230

(57) ABSTRACT

A connection admission control (CAC) technique for a telecommunications node approximates probability of loss using a log moment generating function and its two partial derivatives of workload on a queue over a time interval. The approximation uses four state variables, which depend on the log moment generating function and its two partial derivatives. The four state variables are: (1) Linear term in approximation to log loss ratio at a working point; (2) the argument of logarithmic term in approximation to log loss ratio at the working point; (3) a buffer limit used at the working point; and (4) a multiplier of imaginary traffic used at the working point. Advantageously, these state variables vary linearly with the traffic, so a new connection can simply add its contributions to them. The connection admission control (CAC) uses the state variables to produce the following three parameters: (1) an approximation q=z−log(c) to the logarithm of the probability of loss; (2) a buffer size limit B; and (3) a multiple m of imaginary traffic from a design mix. The traffic on all connections is admissable if four conditions are satisfied. The present invention applies, e.g., to a single queue and server, and can be generalized to multiple queues and servers.

### BACKGROUND

1. Field of the Invention

The present invention pertains to telecommunications, and particular to connection admission control aspects of telecommunications traffic management.

2. Related Art and Other Considerations

In telecommunications, traffic management is the art of providing users with the service they need and have paid for. One aspect of traffic management, connection admission control (CAC), checks to ensure that resource consumption of new connections will not violate the quality of service (QOS) requirements of new and existing connections before admitting the new connections on the network. Relevant resources involved in connection admission control (CAC) are channel numbers, bandwidth, and buffer space.

Within connection admission control (CAC), effective/equivalent bandwidth methods are based on the asymptotic behavior of a tail of a queue length distribution. The algorithms of such methods calculate an effective bandwidth based on the traffic descriptor, QOS requirements, and buffer resources. The effective bandwidth methods are often restricted to a certain type of traffic sources. Some results apply to on-off Markov fluids (see Kesidis, Walrand, Chang, “Effective Bandwidths for Multicall Markov Fluids and Other ATM Sources”, IEEE Trans. Networking, Vol. 1, No. 4, pp. 424-428, August 1993), others to leaky-bucket shaped traffic, see Lo Presti, Zhang, “Source Time Scale and Optimal Buffer/Bandwidth Trade-off for Regulated Traffic in an ATM Node”, UMASS CMPSCI Technical Report UM-CS-96-38.

Some real sources may be closest to the Markov fluid-type model, for instance encoded speech. This type of source needs no further shaping to be suitable for transfer through a network, although it has no maximum burst size. On the other hand, packet traffic is typically leaky bucket shaped with a peak rate, a sustainable rate, and a maximum burst size. The asymptotic behavior of a queue loaded with leaky bucket traffic differs significantly from the behavior of a queue loaded with Markov traffic. The leaky bucket-loaded queue has an upper bound on its length, while the Markov-loaded queue has no upper bound. Using the asymptotic Markov-type results on leaky bucket traffic will completely loose the leaky bucket burstiness information. Using the leaky bucket results with a Markov source does not work because they rely on the limited burst size.

What is needed, therefore, and an object of the invention, is a connection admission control (CAC) technique which is effective in multitudinous traffic scenarios.

### BRIEF SUMMARY OF THE INVENTION

The present invention approximates probability of loss using a log moment generating function and its two partial derivatives of workload on a queue over a time interval. The approximation uses four state variables, which depend on the log moment generating function and its two partial derivatives. The four state variables are as follows:

z(s,t) Linear term in approximation to log loss ratio at working point (s,t)

c(s,t) Argument of logarithmic term in approximation to log loss ratio at working point (s,t)

B(s,t) Buffer limit used at working point (s,t)

m(s,t) Multiplier of imaginary traffic used at working point (s,t)

Advantageously, these state variables vary linearly with the traffic, so a new connection can simply add its contributions to them.

Finding the point (s,t) which optimizes the approximation to the probability of loss with the actual buffer size limit, service, and traffic, in real time is generally not feasible. Instead, the present invention uses a predetermined working point (s,t) and adds some imaginary traffic from a design traffic mix to the actual traffic in order to make the working point the optimizing point for the sum of real and imaginary traffic. This makes it sufficient to keep track of the state variables rather than of whole functions.

The approximation of the invention uses the state variables to produce the following three parameters: (1) an approximation q=z−log(c) to the logarithm of the probability of loss; (2) a buffer size limit B; and (3) a multiple m of imaginary traffic from a design mix.

The traffic on all connections is admissable if the four conditions are satisfied. The first condition is that q be less than or equal to the QOS log loss requirement. The second condition is that B be less than or equal to the limit set by available buffer space and QOS delay requirements. The third condition is that m is nonnegative. The fourth condition is that the mean input rate of real plus imaginary traffic exceeds the mean service rate by no more than admitted by the QOS loss requirement.

If none of the first three conditions is satisfied, the traffic is inadmissible. If some, but not all, of the conditions are satisfied, the algorithm cannot make a determination, and therefore, does not admit the traffic.

To find a good working point, the above calculations are performed off-line for a great number of points (s,t), and a working point is picked from a region in the (s,t)-plane that performs best with the design traffic mix. If it is desired to widen the tolerance against deviations from the design mix, such may be possible by choosing a working point that is not optimal for the design traffic mix. If it is desired to handle several design traffic mixes, a good working point can be selected for each design mix, state variables maintained for each working point, and calculate q, B, and m calculated at each working point at connection set-up. If no working point rejects the traffic, and at least one working point admits the traffic, the traffic is deemed admissible.

The present invention applies, e.g., to a single queue and server. Moreover, the invention can be generalized to multiple queues and servers.

The present invention has a wide range of applicability, working both on a mixture of encoded speech and leaky bucket shaped traffic as well as other types of traffic. The traffic may be of fluid or discrete arrivals type. In examples with known exact answer considered so far the method has admitted between 97% and 100% of what is theoretically admissible. Although more complex than a pure efficient bandwidth method, the invention is implementable in real time.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a graph illustrating causes of underestimating loss.

FIG. 2 is a graph illustrating bounding of x−B by ke^{sx}.

FIG. 3 is a schematic view illustrating a high-priority queue H and a low-priority queue L served by a single server. FIG. 4 is a schematic view illustrating N queues of equal priority served by a single server.

FIG. 5 is a graph showing a simulation of queue length distributions.

FIG. 6 is a schematic view of an example of queues with shared buffer and independent servers.

FIG. 7 is a schematic view of a queueing system in a spatial switch of a wideband CDMA telecommunications system.

FIG. 8A is a graph of a log moment generating function; FIG. 8B is a graph of the derivative with respect to s of the log moment generating function of FIG. 8A; FIG. 8C is a graph of the derivative with respect to t of the log moment generating function of FIG. 8A.

FIG. 9 is a graph showing ON-OFF periodic arrivals.

FIG. 10A is a graph showing the log moment generating function, and FIG. 10B and FIG. 10C its derivatives with respect to s and t, respectively, for ON-OFF periodic source with R=1, T=1, Tₒₙ=0.2.

FIG. 11A is a graph showing the log moment generating function, and FIG. 11B and FIG. 11C are graphs showing the derivatives of the log moment generation function of FIG. 11A with respect to s and t, respectively, for discrete periodic source with T=1, R=1.

FIG. 12A is a graph showing the log moment generating function, and FIG. 12B and FIG. 12C are graphs showing the derivatives of the log moment generation function of FIG. 12A with respect to s and t, respectively, for a Poisson source with T=1, R=1.

FIG. 13A is a graph showing the log moment generating function, and FIG. 13B and FIG. 13C are graphs showing the derivatives of the log moment generation function of FIG. 13A with respect to s and t, respectively, for an ON/OFF Markov fluid source with T=1/Q_{1,2}+1/Q_{2,1}=1, Tₒₙ=1/Q_{1,2}=0.2, R=1.

FIG. 14A is a graph showing the log moment generating function, and FIG. 14B and FIG. 14C are graphs showing the derivatives of the log moment generation function of FIG. 14A with respect to s and t, respectively, for always ON or OFF fluid source with P_{ON}=0.2 and R=1.

FIG. 15A and FIG. 15B are graphs showing contours of q, B, and m for traffic cases 1, 10, respectively.

FIG. 16A-FIG. 16D are graphs showing contours of q, B, and m for traffic cases 2, 3, 4, 5, respectively.

FIG. 17A-FIG. 17B are graphs showing contours of q, B, and m for traffic cases 6, 7, 8, and 9, respectively.

FIG. 18A-FIG. 18D are graphs showing contours of q, B, and m for traffic cases 11, 12, 13, and 14, respectively.

FIG. 19A-FIG. 19D are graphs showing contours of q, B, and m for traffic cases 15, 16, 17, and 18, respectively.

FIG. 20 is a graph showing contours of q, B, and m for a 19^{th} one connection traffic case.

FIG. 21A-FIG. 21D are graphs showing contours of q, B, and m for traffic cases 20, 29, 39, 48, respectively.

FIG. 22A-FIG. 22D are graphs showing contours of q, B, and m for traffic cases 21, 22, 40, 41, respectively.

FIG. 23A-FIG. 23D are graphs showing contours of q, B, and m for traffic cases 23, 24, 42, 43, respectively.

FIG. 24A-FIG. 24D are graphs showing contours of q, B, and m for traffic cases 25, 26, 44, 45, respectively.

FIG. 25A-FIG. 25D are graphs showing contours of q, B, and m for traffic cases 27, 28, 46, 47, respectively.

FIG. 26A-FIG. 26D are graphs showing contours of q, B, and m for traffic cases 30, 31, 49, 50, respectively.

FIG. 27A-FIG. 27D are graphs showing contours of q, B, and m for traffic cases 32, 33, 51, 52, respectively.

FIG. 28A-FIG. 28D are graphs showing contours of q, B, and m for traffic cases 34, 35, 53, 54, respectively.

FIG. 29A-FIG. 29D are graphs showing contours of q, B, and m for traffic cases 36, 37, 55, 56, respectively.

FIG. 30-FIG. 30 are graphs showing contours of q, B, and m for traffic cases 36, 38, 57, respectively.

FIG. 31 is a schematic view of an node according to an embodiment of the invention.

FIG. 32A is a schematic view of an node entity which includes a node main processor.

FIG. 32B is a schematic view of an node entity which serves as an extension terminal.

FIG. 33 is a graph showing a probability density function.

### DETAILED DESCRIPTION OF THE DRAWINGS

1 Introduction

Link Admission Control LAC is part of Connection Admission Control CAC. LAC examines whether resources are available for a new connection on a link. Resources are channel numbers, buffer space and bandwidth. The present invention considers LAC with respect to bandwidth and buffer usage only.

A link may contain several queue-and-server systems, for instance, egress queues in the sending node and ingress queues in the receiving node. LAC must check for resources in every such system. The present invention illustrates an exemplary system.

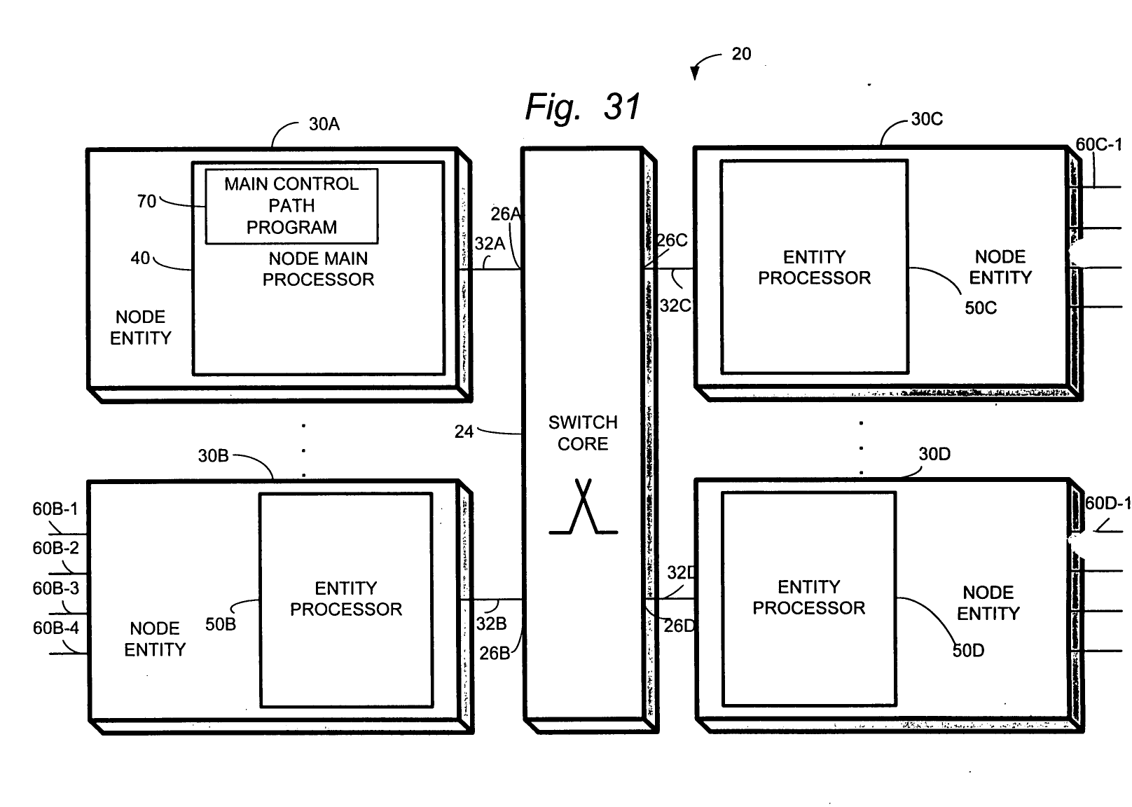

In the above regard, FIG. 31 shows a representative node 20 with which the connection admission control (CAC) technique of the present invention can be employed. The particular node 20 which serves as an illustration of the connection admission control (CAC) of the present invention is an Asynchronous Transfer Mode (ATM) node 20 comprising a switch core 24. Switch core 24 which has plural switch core ports, four of the switch core ports being shown as switch core ports 26A-26D in FIG. 31. A node entity 30, also known as a device board, is connected to each of the switch core ports. FIG. 31 shows node entity 30A being connected by a bidirectional link 32A to switch core port 26A; node entity 30B being connected by another bidirectional link 32B to switch core port 26B; and so forth. It should be understood that more than four node entities 30 can be, and typically are, connected to corresponding ports 26 of switch core 24, but that only four node entities 30 are shown for sake of simplification.

Each node entity 30 performs one or more functions and has, among other components hereinafter described, a processor mounted thereon. One of the node entities 30, particularly node entity 30A, has a node main processor which generally supervises operation of the entire ATM node 20. The other node entities 30, such as node entities 30B-30D, have entity processors 50B-50D, respectively, also known as board processors.

In the particular embodiment shown in FIG. 31, each of node entities 30B-30D serve as extension terminals. Having such function, the node entities 30B-30D are connected by physical lines or links to other ATM nodes. For example, node entity 30B is shown as having four physical lines 60B-1 through 60B-4 to other (unillustrated) ATM node(s). Although not necessarily labeled, in FIG. 31, the other node entities 30B and 30C also have four physical lines extending to other (unillustrated) ATM node(s).

In general, the ATM node 20 serves to route ATM traffic cells between physical lines 60 which connect ATM node 20 to other ATM nodes. For example, ATM traffic cells incoming to ATM node 20 on physical line 60B-1 can be routed by switch core 24 to be outgoing from ATM node 20 on physical line 60C-1. The entity processor of each node entity 30 plays a significant role when establishing ATM connections to/from that entity. In case of an extension terminal (ET) entity, the establishing of an ATM connection between a physical line and another node entity (e.g., another extension terminal or any other type of node entity) is performed by setting up a translation table row (hosted in the ATM line module), one for each direction. In the ingress direction, the translation assigns an internal VPI/VCI and an addressee switch port for each utilized VPI/VCI on the physical link. The addressee switch port is used to route each cell to the right switch port (i.e., node entity). In the egress direction, the translation assigns the VPI/VCI to be used on the physical link for each VPI/VCI used internally between two node entities. When actually transmitting cells on the connection, only hardware is involved (e.g., no processors perform any tasks concerning cell transfer). In the case of any other type of node entity (e.g., an entity that terminates an ATM connection), the principles discussed above apply except for the egress direction in which no external VPI/VCI is assigned. Instead, a termination point (software entity of the processor) is utilized.

As mentioned above, the overall operation of ATM node 20 is managed by node main processor 40. In order to communicate with the node entities 30, and particularly with the entity processors 50 of the respective node entities 30, certain control paths must be established between node main processor 40 and the entity processors 50 so that the processors can communicate with one another. The communication is performed by cells which are transmitted over the control paths established between node main processor 40 and the various entity processors 50. Establishment of these control paths is understood with reference to U.S. patent application Ser. No. 09/249,785 filed Feb. 16, 1999, “Establishing Internal Control Paths in ATM Node,” which is incorporated herein by reference.

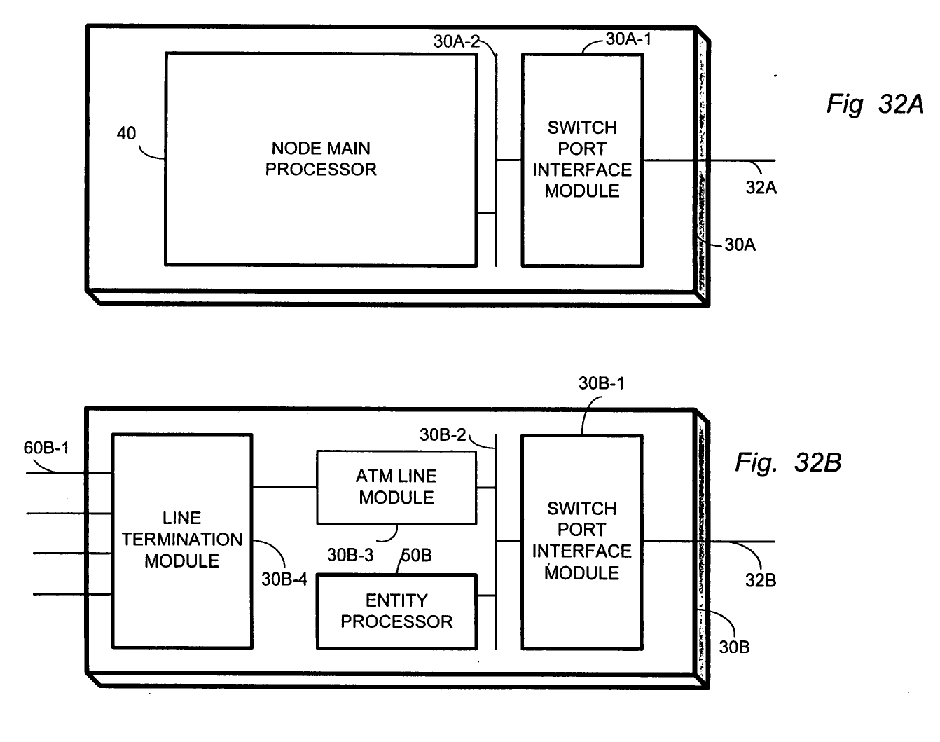

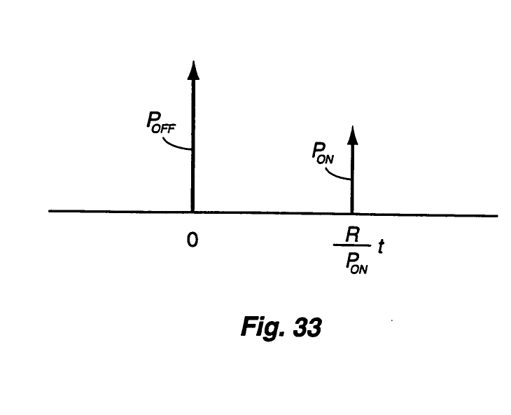

FIG. 32A shows an example node entity 30A at which node main processor 40 is situated. The node entity 30 of FIG. 32A includes a switch port interface module (SPIM) 30A-1 which is connected by bidirectional link 32A to switch core 24. The switch port interface module (SPIM) 30A-1 is connected to bus 30A-2, which is preferably a UTOPIA standard bus. The node main processor 40 is connected by bus 30A-2 to switch port interface module (SPIM) 30A-1. As discussed herein, and particularly illustrated in FIG. 7, the switch port interface modules (SPIMs) have queues which are affected by traffic management.

FIG. 32B shows an example node entity 30 which serves as an extension terminal. Like FIG. 32A, the node entity 30 of FIG. 32B has switch port interface module (SPIM) 30B-1 and bus 30B-2, with a processor (entity processor 50) being connected to bus 30B-2. In addition, bus 30B-2 is connected to ATM line module 30B-3. The ATM line module 30B-3, as hereinafter explained, contains VPI/VCI translation tables used for performing the external/internal VPI/VCI and internal/external VPI/VCI translations described above. The ATM line module 30B-3 is, in turn, connected to line termination module (LTM) 30-4. It is line termination module (LTM) 30B-4 which is connected to the physical lines 60.

Examples of the components of a node entity 30 are described, for example, in the following United States Patent Applications (all of which are incorporated herein by reference): U.S. patent application Ser. No. 08/893,507 for “Augmentation of ATM Cell With Buffering Data”; U.S. patent application Ser. No. 08/893,677 for “Buffering of Point-to-Point and/or Point-to-Multipoint ATM Cells”; U.S. patent application Ser. No. 08/893,479 for “VPI/VCI Look-Up Function”; U.S. Provisional Application Serial No. 60/086,619 for “Asynchronous Transfer Mode Switch.” The structure and operation of node 20 is also further understood with reference to U.S. patent application Ser. No. 09/188,101, “Asynchronous Transfer Mode Switch,” and U.S. patent application Ser. No. 09/188,265, “Asynchronous Transfer Mode Switch”, both of which are incorporated herein by reference.

In the representative node 20 herein described it is node main processor 40 (see FIG. 31) which performs the connection admission control (CAC) procedures of the present invention. In this regard, references hereinafter to an algorithm refer to connection admission control (CAC) procedures executed by node main processor 40. It should be understood that the connection admission control (CAC) procedures of the present invention could be performed for a telecommunications node by a processor located other than on a device board, or by structures other than a processor (e.g., a hardwired circuit). Moreover, although the representative node 20 happens to be an ATM-based node, the connection admission control (CAC) techniques of the present invention are not confined to ATM or to any particular type of telecommunications type (e.g., CDMA). Rather, the connection admission control (CAC) techniques of the present invention can be employed in or for any telecommunications node where traffic management is an issue.

2 Approximations to Bandwidth, Queue Length and Loss Ratio

Consider a general single server queue. A(t) denotes the amount of work which arrives in the interval [−t, 0) and S(t) the amount served in the same interval. If more work arrived than can be processed, the surplus waits in the queue, if possible. The workload process is defined by W(0)=0 and

W(t)=A(t)−S(t)

and the queue of unprocessed work at time zero is

Q=sup W(t)t≧0

In the foregoing,

| | |
|---|---|
| A(t) | is the amount arriving in [−t,0) |
| R | is the mean arrival rate (of stationary arrival |
| | process) |
| S(t) | is the amount that can be served in [−t,0) |
| C | is the mean service rate |
| W(t) = A(t) − S(t) | is the workload in [−t,0) |
| B | is the buffer size |
| f_{w}(x;t) | is the probability density of W(t) |
| Pₗₒₛₛ | is the probability of loss |
| M_{w}(s;t) = E{e^{sW(t)}} | Moment generating function of W(t) |
| μ_{w}(s;t) = logM_{w}(s;t) | is the log moment generating function of W(t) |

If the workload exceeds the buffer size, the excess amount of work, W(t)−B, gets lost. The mean amount of work lost in [−t,0) is

$${RtP}_{loss} ( t ) \geq {\int }_{B}^{∞} ( x - B ) {f}_{W} ( x ; t ) ⅆ x$$

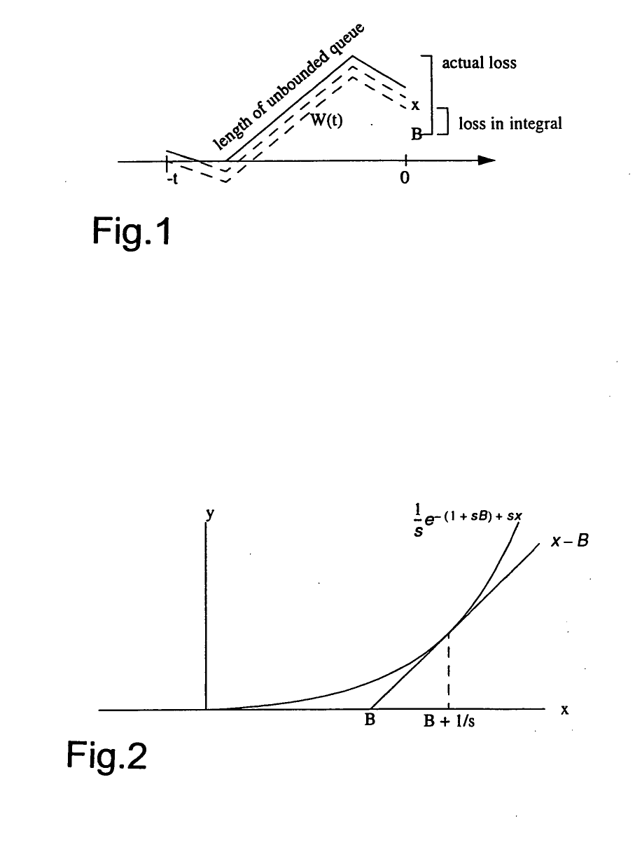

There are three causes for the inequality (illustrated in FIG. 1) are that: (1) the queue may be non-empty at −t; (2) the queue may be empty in part of [−t,0); and (3) the workload may have a maximum within [−t,0).

Solving with respect to Pₗₒₛₛ(t) gives

$${P}_{loss} ( t ) \geq \frac{{\int }_{B}^{∞} ( x - B ) {f}_{W} ( x ; t ) ⅆ x}{Rt}$$

Now the integral is upper bounded by an exponential bound on the factor (x−B),

$$k {ⅇ}^{sx} > \{ \begin{matrix}0 & x < B \\ x - B & x \geq B\end{matrix}$$

where s is a positive parameter and k is a constant chosen such that the curve y=ke^{sx} touches the straight line y=x−B. This happens with

$$k = \frac{1}{s} {ⅇ}^{- ( 1 + sB )} ,$$

as illustrated in FIG. 2. This type of bound is an integrated Chernoff bound.

The upper bound on the average amount of work lost in [−t,0) becomes

$$\begin{matrix}{\int }_{B}^{∞} ( x - B ) {f}_{W} ( x ; t ) ⅆ x \leq \frac{1}{s} {ⅇ}^{- ( 1 + sB )} {\int }_{B}^{∞} {ⅇ}^{sx} {f}_{W} ( x ; t ) ⅆ x \\ \leq \frac{1}{s} {ⅇ}^{- ( 1 + sB )} {\int }_{- ∞}^{∞} {ⅇ}^{sx} {f}_{W} ( x ; t ) ⅆ x \\ = \frac{1}{s} {ⅇ}^{- ( 1 + sB )} {M}_{W} ( s ; t ) \\ = {ⅇ}^{{μ}_{W} ( s ; t ) - sB - 1 - log ( s )}\end{matrix}$$

where M_{w}(s;t)=E{e^{sW(t)}} is the moment generating function of f_{W}(x;t) and μ_{W}(s;t)=log_{W}(s;t) is the log moment generating function of f_{W}(x;t). The bound applies with equality if and only if f_{W}(x;t) consists of a single delta-impulse at x=B+1/s, where the exponential curve touches the line y=x−B.

The bound is tightest for the s that minimizes μ_{W}(s;t)−sB−1−log s. The s that gives the tightest bound must satisfy

$$\frac{\partial }{\partial s} {μ}_{W} ( s ; t ) - B - \frac{1}{s} = 0$$

An s satisfying this equation does indeed always give a minimum. To prove this, show that the second order derivative is positive,

$$\frac{{\partial }^{2}}{\partial {s}^{2}} {μ}_{W} ( s ; t ) + \frac{1}{{s}^{2}} > 0$$

The proof is outlined using a probability shift argument. The function f_{W}(x;t)e^{sx-μ}^{_{w}}^{(s;t)} is a probability density function, because it is non-negative and its integral over all x is 1. A random variable with this probability density has mean

$$\frac{\partial }{\partial s} {μ}_{W} ( s ; t )$$

and variance

$$\frac{{\partial }^{2}}{\partial {s}^{2}} {μ}_{W} ( s ; t ) .$$

Since a variance is non-negative, this concludes the proof.

The lower bound on Pₗₒₛₛ(t) and the upper bound on the integral can be combined into the following approximation:

log Pₗₒₛₛ(t)≈q

where q=μ_{W}(s; t)−Bs−1−log(Rst)

$$and \qquad B = \frac{\partial }{\partial s} {μ}_{W} ( s ; t ) - \frac{1}{s}$$

for all s,t>0

The maximum of q over all time interval lengths t is used as an approximation to the probability of loss. Assuming derivatives exist, a necessary condition for maximum is dq/dt=0. Differentiating:

$$ⅆ q = - s ⅆ B + ( \frac{\partial }{\partial s} {μ}_{W} ( s ; t ) - B - \frac{1}{s} ) ⅆ s + ( \frac{\partial }{\partial t} {μ}_{W} ( s ; t ) - \frac{1}{t} ) ⅆ t$$

Keeping the buffer limit constant, dB=0, and using the minimizing s, we get the necessary conditions for maximum

$$\frac{ⅆ q}{ⅆ t} = \frac{\partial }{\partial t} {μ}_{W} ( s ; t ) - \frac{1}{t} = 0$$

Using the s and t found above, it is found that

$$\frac{ⅆ q}{ⅆ B} = - s$$

Thus, −s is the slope of q versus B.

There is no general guarantee that dq/dt=0 gives a global maximum. Periodic arrival processes give several local maxima and minima.

A necessary condition that the solution found above is a local maximum rather than a minimum is d²q/dt²<0.

$$\frac{{ⅆ}^{2} q}{ⅆ {t}^{2}} = \frac{{\partial }^{2}}{\partial {t}^{2}} {μ}_{W} ( s ; t ) - \frac{{( \frac{{\partial }^{2}}{\partial t \partial s} {μ}_{W} ( s ; t ) )}^{2}}{\frac{{\partial }^{2}}{\partial {s}^{2}} {μ}_{W} ( s ; t ) + \frac{1}{{s}^{2}}} + \frac{1}{{t}^{2}} \leq 0$$

This condition has not had any practical significance in the examples tested. The solutions it excluded did not admit the traffic anyway for other reasons.

A necessary condition that a local minimum is also global is that the queue is stable, that is, the mean arrival rate is less than or equal to the mean service rate, R<C. Unfortunately, this simple condition excludes the results with constant arrival rate and constant service rate for all s,t>0, although these results are exact, see Example 1 in Section 5.1 hereof pertaining to constant arrival rates. These results are a buffer size of B=0, and an excess arrival rate of 1/(st), which gets lost. To allow for this case, the weaker condition is used:

R−C≦Re^{q}^{ₘₐₓ}

This condition is important in conjunction with periodic arrival processes. They give local maxima in every period, even under heavy overload conditions; but the condition shows that the maxima can not be global.

The results are summarized as follows:

$$\begin{matrix}log {P}_{loss} \approx q \\ \begin{matrix}where & & q = {μ}_{W} ( s ; t ) - Bs - 1 - log ( Rst )\end{matrix} \\ \begin{matrix}and & & B = \frac{\partial }{\partial s} {μ}_{W} ( s ; t ) - \frac{1}{s}\end{matrix} \\ \begin{matrix}and & & 0 = \frac{\partial }{\partial t} {μ}_{W} ( s ; t ) - \frac{1}{t}\end{matrix} \\ \begin{matrix}for & & s , t > 0 & & \begin{matrix}and & & R - C \leq R {ⅇ}^{{q}_{max}}\end{matrix}\end{matrix}\end{matrix} \qquad ( 1 )$$

2.1 Constant Service Rate

Assume that the arrival and service processes are independent, and that the service process has a constant rate, C. This gives

μ_{W}(s;t)=μ_{A}(s;t)+μ_{S}(−s;t)=μ_{A}(s;t)−Cst

q and its differential become

q=μ_{A}(s;t)−Bs−Cst−1−log(Rst)

$$\begin{matrix}ⅆ q = - s ⅆ B - st ⅆ C + ( \frac{\partial }{\partial s} {μ}_{A} ( s ; t ) - B - Ct - \frac{1}{s} ) ⅆ s + \\ ( \frac{\partial }{\partial t} {μ}_{A} ( s ; t ) - Cs - \frac{1}{t} ) ⅆ t\end{matrix}$$

Again, to minimize q for constant B, C, and t, the coefficient of ds must be 0. To maximize q for constant B, C, and the minimizing s, the coefficient of dt must be 0. The s and t determined like this have the following interpretation:

−s is the slope of q versus B for constant C

−st is the slope of q versus C for constant B

The result for constant service rate C is

$$\begin{matrix}log {P}_{loss} = q \\ \begin{matrix}where & & q = {μ}_{A} ( s ; t ) - Cst - Bs - 1 - log ( Rst )\end{matrix} \\ \begin{matrix}and & & B = \frac{\partial }{\partial s} {μ}_{A} ( s ; t ) - Ct - \frac{1}{s}\end{matrix} \\ \begin{matrix}and & & C = \frac{1}{s} ( \frac{\partial }{\partial t} {μ}_{A} ( s ; t ) - \frac{1}{t} ) \end{matrix} \\ \begin{matrix}for & & s , t > 0 & & \begin{matrix}and & & R - C \leq R {ⅇ}^{{q}_{max}}\end{matrix}\end{matrix}\end{matrix} \qquad ( 2 )$$

2.2 General Service

Solving equations (1) for (s,t) is difficult. Instead, we shall use (1) with the actual arrivals and service replaced by something else.

The “unused typical arrivals” problem formulation in section 2.2.1 presents a solution in a form suitable for implementation in a real-time CAC algorithm. It's suitability comes from a “single point calculation” property.

The problem formulations in sections 2.2.2-2.2.4 are special cases and variants of this. Despite the solutions look simpler they are less suitable for implementation in a real-time CAC algorithm. This is because they do not have the “single point calculation” property, but rather a “leaning banana” trouble.

2.2.1 Unused Typical Arrivals Formulation

Replace the actual arrivals A(t) by A(t)+U(t), where U(t) is unused typical arrival traffic.

Generate U(t) as follows: Choose a typical set of connections, and call its mean arrival rate R₀ and its log moment generating function μ₀(s;t). Add independent connections in the same proportions as in the typical set, but m times as many, to form U(t) with mean arrival rate mR₀ and log moment generating function μ_{U}(s;t)=mμ₀(s;t). Choose m such that the traffic satisfies equations (1).

The result for general service S(t) with unused typical arrivals is

$$\begin{matrix}log {P}_{loss} \approx q \\ \begin{matrix}where & & \begin{matrix}q = {μ}_{W} ( s ; t ) - s \frac{\partial }{\partial s} {μ}_{W} ( s ; t ) + \\ m ( {μ}_{0} ( s ; t ) - s \frac{\partial }{\partial s} {μ}_{0} ( s ; t ) ) - log ( ( R + {mR}_{0} ) st )\end{matrix}\end{matrix} \\ \begin{matrix}and & & B = \frac{\partial }{\partial s} {μ}_{W} ( s ; t ) + m \frac{\partial }{\partial s} {μ}_{0} ( s ; t ) - \frac{1}{s}\end{matrix} \\ \begin{matrix}and & & m = - \frac{\frac{\partial }{\partial t} {μ}_{W} ( s ; t ) - \frac{1}{t}}{\frac{\partial }{\partial t} {μ}_{0} ( s ; t )}\end{matrix} \\ \begin{matrix}for & & s , t > 0 & & \begin{matrix}and & & R + {mR}_{0} - C \leq ( R + {mR}_{0} ) {ⅇ}^{{q}_{max}}\end{matrix}\end{matrix}\end{matrix} \qquad ( 3 )$$

It should be noted that m=0 corresponds to the maximum admissible load of real traffic. If m is non-negative, the service S(t) is sufficient, otherwise S(t) is insufficient. B and q in (3) are not the actual buffer size and log loss probability, but the buffer size and log loss probability that would arise if the unused typical arrivals were added to the actual arrivals.

The terms m and B in (3) are linear functions of the derivatives of μ_{W}(s;t). q is the sum of a linear and a logarithmic term.,

q=z−log c

$$\begin{matrix}\begin{matrix}where & z = {μ}_{W} ( s ; t ) - s \frac{\partial }{\partial s} {μ}_{W} ( s ; t ) + m ( {μ}_{0} ( s ; t ) - s \frac{\partial }{\partial s} {μ}_{0} ( s ; t ) ) - log ( st )\end{matrix} \\ \begin{matrix}and & & c = R + {mR}_{0}\end{matrix}\end{matrix} \qquad ( 4 )$$

A CAC algorithm can keep track of c, z, B, and m by adding contributions from new connections and subtracting contributions from connections being cleared.

The “unused typical arrivals” formulation of the problem has a “single point calculation” advantage. If the real arrivals come from a typical traffic mix, then the mean rate and log moment generating function of A(t)+U(t) do not vary with the real traffic load. This means that a point (s,t) that admits the traffic at the maximum admissible load also admits at all lower loads. If the real traffic deviates from the typical mix the sum of real and imaginary traffic may still be sufficiently similar to the typical mix to allow a single point (s,t) to admit over a range of real traffic mixes and loads.

2.2.2 Unused Arrival Bandwidth Formulation

Replace the actual arrivals A(t) by A(t)+Ut, where U is the unused arrival bandwidth.

The result for general service S(t) with unused arrival bandwidth U is

$$\begin{matrix}log {P}_{loss} \approx q \\ \begin{matrix}where & & q = {μ}_{W} ( s ; t ) + Ust - Bs - 1 - log ( ( R + U ) st )\end{matrix} \\ \begin{matrix}and & & B = \frac{\partial }{\partial s} {μ}_{W} ( s ; t ) + Ut - \frac{1}{s}\end{matrix} \\ \begin{matrix}and & & U = - \frac{1}{s} ( \frac{\partial }{\partial t} {μ}_{W} ( s ; t ) - \frac{1}{t} )\end{matrix} \\ \begin{matrix}for & & s , t > 0 & & \begin{matrix}and & & R + U - C \leq ( R + U ) {ⅇ}^{{q}_{max}}\end{matrix}\end{matrix}\end{matrix} \qquad ( 5 )$$

If U is non-negative, S(t) is sufficient, otherwise S(t) is insufficient. B and q in Equation Block (5) are not the actual buffer size and log loss probability, but the buffer size and log loss probability that would arise if the actual arrivals were increased by the unused bandwidth.

The log loss probability q in Equation Block (5) is the sum of a linear and a logarithmic term,

q=z−log(R+U)

where z=μ_{W}(s; t)+Ust−Bs−1−log(st)

An admission control algorithm can keep track of B, R, U, and z by adding contributions from new connections and subtracting contributions from connections being cleared.

A drawback of using Equation Block (5) for real-time admission control is that the (s,t)-region admitting the last connection does not always overlap the (s,t)-region admitting the first connection. In (s,t,load)-space the region admitting the loads may look like a “leaning banana”. Thus, it is not sufficient just to calculate Equation Block (5) in a single point (s,t).

2.2.3 Unused Service Bandwidth Formulation

Replace the actual service S(t) by S(t)-Ut, where U is the unused service bandwidth.

This gives the same workload on the queue as in the unused arrival bandwidth formulation. U and B are the same as before, but q is greater when U>0. At full load, when U=0, the two unused bandwidth formulations give the same result.

The result for general service S(t) with unused service bandwidth U is

$$\begin{matrix}log {P}_{loss} \approx q \\ \begin{matrix}where & & q = {μ}_{W} ( s ; t ) + Ust - Bs - 1 - log ( Rst )\end{matrix} \\ \begin{matrix}and & & B = \frac{\partial }{\partial s} {μ}_{W} ( s ; t ) + Ut - \frac{1}{s}\end{matrix} \\ \begin{matrix}and & & U = - \frac{1}{s} ( \frac{\partial }{\partial t} {μ}_{W} ( s ; t ) - \frac{1}{t} )\end{matrix} \\ \begin{matrix}for & & s , t > 0 & & \begin{matrix}and & & R - ( C - U ) \leq R {ⅇ}^{{q}_{max}}\end{matrix}\end{matrix}\end{matrix} \qquad ( 6 )$$

If U is non-negative, S(t) is sufficient, otherwise S(t) is insufficient. B and q in (6) are not the actual buffer size and log loss probability, but the buffer size and log loss probability that would arise if the actual service was reduced by the unused bandwidth.

The set of points (s,t) admitting the arrivals differs between the two unused bandwidth formulations. If Equation Block (6) admits the arrivals at (s,t), then so does Equation Block (5); but the converse is not true. If Equation Block (5) admits the arrivals at (s,t), the Equation Block (6) may admit or be uncertain.

The log loss probability q in Equation Block (6) is the sum of a linear and a logarithm term,

q=z−log R

where z=μ_{W}(s; t)+Ust−Bs−1−log(st)

B, R, U, and z are all linear functions of the log moment generating function of the workload W(t). An admission control algorithm can keep track of B, R, U, and. z by adding contributions from new connections and subtracting contributions from connections being cleared.

The unused service bandwidth formulation suffers from the same “leaning banana” trouble as does the unused arrival bandwidth formulation.

2.2.4 Arrivals Multiplier Formulation

Imagine increasing the arrivals k times by adding independent connections from the same traffic mix as the actual connections. The resulting arrivals have mean rate and log moment generating function

Rₖ=kR

μ_{kA}(s; t)=kμ_{A}(s; t)

Select the multiplier k such that the workload resulting from imaginary arrivals and actual service satisfies Equation Block (1). The result is

$$\begin{matrix}log {P}_{loss} \approx q \\ \begin{matrix}where & & q = k {μ}_{A} ( s ; t ) + {μ}_{s} ( - s ; t ) - Bs - 1 - log ( kRst )\end{matrix} \\ \begin{matrix}and & & B = k \frac{\partial }{\partial s} {μ}_{A} ( s ; t ) + \frac{\partial }{\partial s} {μ}_{s} ( - s ; t ) - \frac{1}{s}\end{matrix} \\ \begin{matrix}and & & k = - \frac{\frac{\partial }{\partial t} {μ}_{s} ( - s ; t ) - \frac{1}{t}}{\frac{\partial }{\partial t} {μ}_{A} ( s ; t )}\end{matrix} \\ \begin{matrix}for & & s , t > 0 & & \begin{matrix}and & & kR - C \leq kR {ⅇ}^{{q}_{max}}\end{matrix}\end{matrix}\end{matrix} \qquad ( 7 )$$

If k≧1, B≦B₀, q≦q₀ at some (s,t), the connections are admissible. If k<1, B>B₀, q>q₀ at some (s,t), the connections are inadmissible.

The admission control algorithm of the present invention keeps track of four state variables

$$R , {μ}_{A} ( s ; t ) , \frac{\partial }{\partial s} {μ}_{A} ( s ; t ) , \frac{\partial }{\partial t} {μ}_{A} ( s ; t )$$

by adding contributions from new connections. The algorithm can calculate q, B, and k from these state variables.

The arrivals multiplier formulation suffers from the same problem as the unused bandwidth formulation, that the point (s,t) that admits the last connection at maximum load will in general not admit the first connection.

2.3 Asymptotic Expressions for Large t

Assume that the workload process W is stationary and ergodic. Assume that it satisfies the conditions of the Gärtner-Ellis theorem; that is, assume that the asymptotic log moment generating function

$${h}_{W} ( s ) = {lim}_{t \to ∞} \frac{1}{t} {μ}_{W} ( s ; t )$$

exists and is finite for all real s, and that h_{W} is differentiable. That h_{W} is convex, positive and increasing for s>0 can be directly verified. This means that for large t the following approximation can be used:

μ_{W}(s; t)=h_{W}(s)t

For constant rate and Poisson process, this product form of μ_{W}(s;t) holds for all t. For other interesting processes, e.g. leaky bucket shaped traffic, it is poor for small t. If μ_{A}(s:t)=h_{A}(s)t and the service process has constant rate C, the results becomes

$$\begin{matrix}log {P}_{loss} \approx q \\ \begin{matrix}where & q = {h}_{A} ( s ) t - Cst - Bs - 1 - log ( Rst )\end{matrix} \\ \begin{matrix}and & & B = {h}_{A}^{′} ( s ) t - Ct - \frac{1}{s}\end{matrix} \\ \begin{matrix}and & & C = \frac{1}{s} ( {h}_{A} ( s ) - \frac{1}{t} )\end{matrix} \\ \begin{matrix}for & & s , t > 0 & & R \leq C + \frac{1}{st} \end{matrix}\end{matrix}$$

3 Delay

3.1 Constant Service Rate

For a given pair (s,t), Equation Block 3 gives a buffer size B and the logarithm q of the probability of exceeding B. Data arriving to a B long queue served at constant rate C will leave the queue after a delay of D=B/C. If the imaginary traffic is positive, the delay of the real traffic will be smaller. Hence, the (1−e^{q}) fractile of the delay is at most B/C, and

$$P ( D > \frac{B}{C} ) \leq {ⅇ}^{q} \qquad ( 8 )$$

where the equality sign applies when the system is fully loaded.

4 Multiple Queues

4.1 Multiple Priorities, Single Server

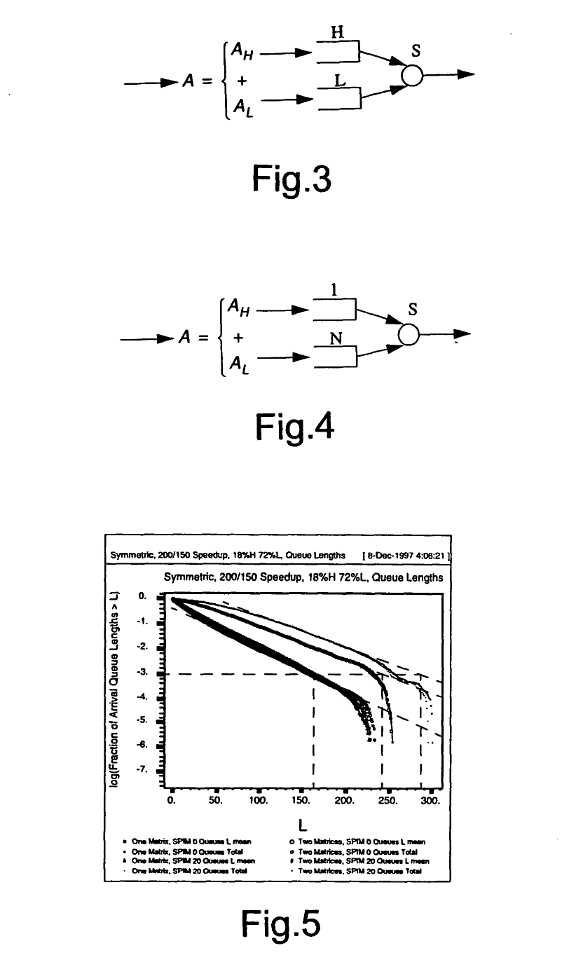

Consider a system consisting of two queues, H and L, served by a single server as shown in FIG. 3. The server serves queue H whenever that queue is not empty. The server serves queue L when queue H is empty and queue L is not. Queue H sees the full service of the server. Queues H and L together also see the full service of the server. Queue L sees what queue H leaves unused. The log moment generating function of the service offered to queue L is determined as follows.

The workload on queue H is W_{H}(t)=A_{H}(t)−S(t). The service offered to queue L is

$${S}_{L} ( t ) = {( S ( t ) - {A}_{H} ( t ) )}^{+} = - {W}_{H}^{-} ( t )$$

$$where \qquad {W}_{H}^{-} ( t ) \{ \begin{matrix}{W}_{H} ( t ) & for {W}_{H} ( t ) < 0 \\ 0 & for {W}_{H} ( t ) \geq 0\end{matrix}$$

From this, the log moment generating function of the service offered to queue L is determined:

μ_{S}_{_{L}}(s;t)=μ_{W}_{⁻}_{H}(−s;t)

This is a function of μ_{A}_{_{H}} (s; t), but unfortunately, a non-linear one. This means that contributions can not just be added to it from every high-priority connection. A practical approximation is to replace W_{H}⁻ by W_{H} and use

μ_{S}_{_{L}}(s; t)≈μ_{W}_{_{H}}(−s; t) (9)

This is equivalent to loading queue L by the total traffic A and offering it the full service S. It is a good approximation if the probability of positive workload on queue H is small.

4.1.1 Admission Control for Multiple Priorities, Single Server, Shared Buffer

In this scenario, queues H and L share a common buffer of limited size. Equation Block (3) is used with workload W_{H}=A_{H}−S to evaluate q_{H} at a pair (s,t).

If q_{H} is admissible, use Equation Block (3) with workload W=A−S. Evaluate the overall variables m, B, and q at (s,t). Find the low-priority log loss probability as the solution of the following loss rate equation.

Re^{q}=R_{H}e^{q}^{_{H}}+R_{L}e^{q}^{_{L}}

If q_{L}≠0, the solution is

$${q}_{L} = log \frac{R {ⅇ}^{q} - {R}_{H} {ⅇ}^{{q}_{H}}}{{R}_{L}} .$$

To prevent division by 0, check that

Re^{q}−R_{H}e^{q}^{_{H}}≦R_{L}e^{q}^{_{Lmax}} (10)

instead of checking q_{L}≦q₁ₘₐₓ directly.

Show that all of m, B, q_{H}, and q_{L} are admissible or inadmissible at (s,t), if possible.

There may be more than two priority levels. Evaluate q_{L} of the each lower level as above using the q of the total traffic on this and all higher levels. At the lowest level, show that m, B, q_{H}, and all q_{L} are admissible or inadmissible at (s,t), if possible.

4.1.2 Admission Control for Multiple Priorities, Single Server, Individual Buffers

In this scenario, queue H has a buffer of limited size, and queue L has a buffer of limited size. Equation Block (3) is used with workload W_{H}=A_{H}−S. Show that all of the high priority variables m_{H}, B_{H}, and q_{H} are admissible or inadmissible at a pair (s_{H},t_{H}), if possible.

If m_{H}, B_{H}, and q_{H} are admissible, use Equation Block (3) with workload W_{L}=A_{L}−S_{L}, approximating S_{L} as in Equation Block (6). Show that all of the low-priority variables m_{L}, B_{L}, and q_{L} are admissible or inadmissible at a pair (S_{L},t_{L}), if possible.

There may be more than two priority levels. Repeat the evaluation for layer L for each lower priority level using the sum of traffic on all higher layers for A_{H}.

4.2 Single Priority

Consider a system consisting of N queues served by a single service as illustrated in FIG. 4. The server serves the non-empty queues according to a schedule giving them an equal share of the service. This schedule could be round robin or according to a snapshot of queue states taken when a previous snapshot has been processed. The N queues together see the full service of the server. An individual queue sees what the other queues leave unused. The situation looks like the one for a low-priority queue seeing the service the high-priority queues leave unused, and we shall use the same approximation (Equation 9), restated here for convenience.

μ_{S}_{_{L}}(s; t)≈μ_{W}_{_{H}}(−s; t) (9)

Here S_{L} is the service seen by an individual queue, and W_{H} is the total workload on the other queues. Again, this approximation gives the same distribution of the length of one queue as the distribution of the sum of the lengths of all the queues. FIG. 5 shows a simulation result justifying such approximation.

FIG. 5 shows distributions of queue lengths. The system comprised 21 queues of equal, low, priority served by a single server. Equal traffic load on all queues with exponentially distributed time between bursts, geometrically distributed number of arrivals in a burst, and constant inter-arrival time within a burst. Scheduling according to a snapshot of queue states, queue 0 served first and queue 20 last. In FIG. 5, the lower set of curves shows the length of queue 0, which was served first in the snapshot; the middle set of curves shows the length of queue 20, which was served last in the snapshot; and the top set of curves shows the sum of the lengths of all 21 queues.

4.2.1 Admission control for Single Priority, Single Server, Shared Buffer

In this scenario, the N queues share a common buffer of limited size. This case is equivalent to the single queue case. Equation Block (3) is used with workload W=A−S. Evaluate the overall variables m, B, and q at a pair (s,t). Show that all of U, B and q are admissible or inadmissible at (s,t), if possible.

4.2.2 Admission Control for Single priority, Single Server, Individual Buffers

In this scenario each of the N queues has a buffer of limited size. Let A_{L} be the arrivals to the queue considered, and let A_{H} be the sum of arrivals to the other queues. Equation Block (3) is used with service S_{L}=S−A_{H}. Show that the variables m_{L}, B_{L}, and q_{L} of the queue considered are all admissible or inadmissible at a pair (S_{L},t_{L}), if possible.

4.3 Queues with Individual Service and Shared Buffer

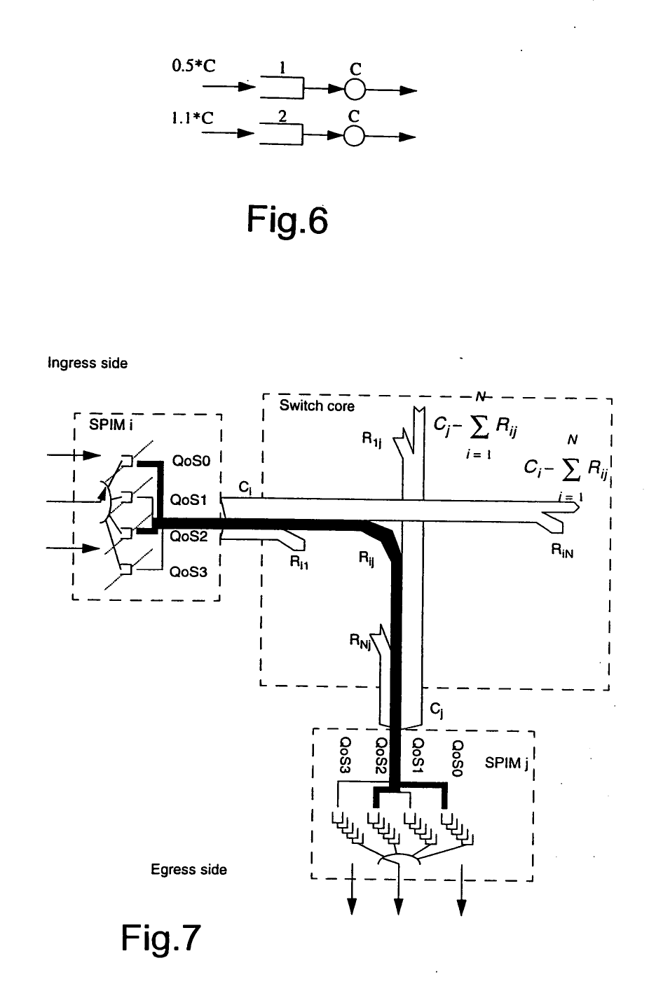

The sum of workloads on queues with independent servers does not give a correct estimate of the sum of queue sizes. FIG. 6 shows an example illustrating this point. In FIG. 6, queue 2 is unstable and grows beyond all limits, while the sum of workloads on the queues is less than the sum of services. It is postulated that the total buffer needed for queues with independent servers is approximately equal to the need of the longest queue. A motivation is that the queues are independent and a long queue has a small probability, so when one queue is long, the others are likely to be around their mean length which is much smaller.

4.4 Queues in the SPAS Switch

FIG. 7 shows a simplified diagram of the queueing system in the spatial switch SPAS (core 24 in FIG. 31) in a wideband CDMA telecommunications system. As mentioned above, details of the spatial switch SPAS beyond those present here are discussed in U.S. patent application Ser. No. 09/188,101, “Asynchronous Transfer Mode Switch,” and U.S. patent application Ser. No. 09/188,265, “Asynchronous Transfer Mode Switch”, both of which are incorporated herein by reference.

The switch core 24 comprises rows for incoming data and columns for outgoing data. In the crosspoints between rows and columns there are small buffers which are omitted in FIG. 7. The space switch interface modules SPIM contain ingress and egress queues towards and from the switch core, respectively.

The ingress queues in a SPIM are organized as a queue per egress SPIM and ingress priority. The idea is to store incoming cells in ingress queues and transfer them in an ingress priority order towards the switch core when the corresponding crosspoint is free. Ingress queue (i, j, p) is located in SPIM i and carries traffic towards SPIM j on priority level p.

The ingress queues in a SPIM share a common buffer memory. Ingress queues in different SPIMs do not share a buffer.

The reading of cells from the ingress queues follows the following rules:

Cells with the highest priority will be fetched until the queues are empty or blocked by occupied crosspoints.

Lower priority cells will be read as soon as there are no cells in queues with higher priority or that all of the higher priority cells are blocked by occupied crosspoints.

A round-robin mechanism is used to give equal bandwidth to the different ingress queues within the same priority level.

The switch core has two priority levels. To get a high priority cell through the switch core when a low priority cell blocks the crosspoint, a command is sent as a special management cell called Plus Priority cell. This cell is terminated in the core and any cell in the crosspoint buffer gets its priority increased. In this way, the crosspoint will be emptied within a predetermined time.

The egress SPIM serves the crosspoints in its column according to a snapshot mechanism. When the SPIM has processed a previous snapshot it takes a new snapshot of the crosspoint buffer states. The SPIM empties the non-empty buffers in the snapshot in increasing number order.

The egress queues are organized as a queue per egress priority and outgoing branch from the SPIM. The idea is to store incoming cells in queues and transfer them in egress priority order. The egress queues in a SPIM share a common buffer memory. This memory is separate from the ingress buffer memory.

4.4.1 Ingress Admission Control

This section describes how to use the “unused typical arrivals” results for admission control of the ingress queues.

Row i and column j in the switch core both limit the service of the ingress queues in SPIM i towards SPIM j. The ingress admission control algorithm checks that both of these potential bottlenecks give sufficient service.

The ingress queues served by a row share a buffer in a SPIM. Hence it suffices to keep track of the total workload per priority level when checking for row service.

The ingress queues served by a column reside in different SPIMs, and therefore do not share a buffer. Hence one must keep track on workload on individual queues when checking for column service. Queues sharing a buffer in a SPIM do not share column service.

The ingress admission control algorithm for row service uses the following state variables for some set of points (s;t),

C_{R}(p,i) Average rate of real+imaginary traffic on priority levels p and higher from SPIM i

Z_{R}(p,i,s;t) Linear term in long loss probability of traffic on priority levels p and higher from SPIM i

B_{R}(p,i,s;t) Buffer size of traffic on priority levels p and higher from SPIM i

m_{R}(p,i,s;t) Multiplier of unused typical traffic on-priority levels p and higher on row i

The ingress admission control algorithm for column service uses the following state variables for some set of points (s;t),

c_{C}(p,i,j) Average rate of real+imaginary traffic on priority levels p and higher from SPIM i towards SPIM j

z_{C}(pi,j,s;t) Linear term in log loss probability of traffic on priority levels p and higher from SPIM i towards SPIM j

B_{C}(p,i,j,s;t) Buffer size of traffic on priority levels p and higher from SPIM i towards SPIM j

m_{C}(p,j,s;t) Multiplier of unused typical traffic on priority levels p and higher on column j

The typical traffic has the following characteristics for some set of points (s;t),

R₀(p,i) Average rate of typical traffic on priority levels p and higher from SPIM i

μ₀(p,i,s;t) Log moment generating function of typical traffic on priority levels p and higher from SPIM i

$$\frac{\partial }{\partial s} {μ}_{0} ( p , i , s ; t )$$

Partial derivative with respect to s, typical traffic on priority levels p and higher from SPIM i

$$\frac{\partial }{\partial t} {μ}_{0} ( p , i , s ; t )$$

Partial derivative with respect to t, typical traffic on priority levels p and higher from SPIM i

For shortness, the coefficients of

$$\frac{\partial {μ}_{A}}{\partial t}$$

are introduced:

$${a}_{R} ( p , i , s ; t ) = \frac{{R}_{0}}{\frac{\partial }{\partial t} {μ}_{0} ( p , i , s ; t )}$$

in the expression for R

$${a}_{z} ( p , i , s ; t ) = \frac{{μ}_{0} ( p , i , s ; t ) - s \frac{\partial }{\partial s} {μ}_{0} ( p , i , s ; t )}{\frac{\partial }{\partial t} {μ}_{0} ( p , i , s ; t )}$$

in the expression for z

$${a}_{B} ( p , i , s ; t ) = \frac{\frac{\partial }{\partial s} {μ}_{0} ( p , i , s ; t )}{\frac{\partial }{\partial t} {μ}_{0} ( p , i , s ; t )}$$

in the expression for B

$${a}_{m} ( p , i , s ; t ) = \frac{1}{\frac{\partial }{\partial t} {μ}_{0} ( p , i , s ; t )}$$

in the expression for m

The initial values for row service, with no traffic through the queues, are

$$\begin{matrix}{c}_{R} ( p , i , s ; t ) = {a}_{R} ( p , i , s ; t ) ( {C}_{i} s + \frac{1}{t} ) \\ {z}_{R} ( p , i , s ; t ) = {a}_{z} ( p , i , s ; t ) ( {C}_{i} s + \frac{1}{t} ) - log ( st ) \\ {B}_{R} ( p , i , s ; t ) = - {C}_{i} t + {a}_{B} ( p , i , s ; t ) ( {C}_{i} s + \frac{1}{t} ) - \frac{1}{s} \\ {m}_{R} ( p , i , s ; t ) = {a}_{m} ( p , i , s ; t ) ( {C}_{i} s + \frac{1}{t} )\end{matrix} \qquad ( 11 )$$

The initial values for column service, with no traffic through the queues, are

$$\begin{matrix}{c}_{C} ( p , i , j , s ; t ) = {a}_{R} ( p , i , s ; t ) ( {C}_{j} s + \frac{1}{t} ) \\ {z}_{C} ( p , i , j , s ; t ) = {a}_{z} ( p , i , s ; t ) ( {C}_{j} s + \frac{1}{t} ) - log ( st ) \\ {B}_{C} ( p , i , j , s ; t ) = - {C}_{j} t + {a}_{B} ( p , i , s ; t ) ( {C}_{j} s + \frac{1}{t} ) - \frac{1}{s} \\ {m}_{C} ( p , i , j , s ; t ) = {a}_{m} ( p , i , s ; t ) ( {C}_{j} s + \frac{1}{t} )\end{matrix} \qquad ( 12 )$$

Input to the ingress admission control algorithm about a new connection is

pₐ Priority level

i Ingress SPIM

j Egress SPIM

r Average rate

μₐ(s;t) Log moment generating function of arrivals at a set of points (s;t)

$$\frac{\partial }{\partial s} {μ}_{a} ( s ; t )$$

Partial derivative with respect to s

$$\frac{\partial }{\partial t} {μ}_{a} ( s ; t )$$

Partial derivative with respect to t

The new connection adds the following contributions to the row state variables,

$$\begin{matrix}Δ {c}_{R} ( p , i , s ; t ) = r - {a}_{R} ( p , i , s ; t ) \frac{\partial }{\partial t} {μ}_{a} ( s ; t ) \\ Δ {z}_{R} ( p , i , s ; t ) = {μ}_{a} ( s ; t ) - s \frac{\partial }{\partial s} {μ}_{a} ( s ; t ) - {a}_{z} ( p , i , s ; t ) \frac{\partial }{\partial t} {μ}_{a} ( s ; t ) \\ Δ {B}_{R} ( p , i , s ; t ) = \frac{\partial }{\partial s} {μ}_{a} ( s ; t ) - {a}_{B} ( p , i , s ; t ) \frac{\partial }{\partial t} {μ}_{a} ( s ; t ) \\ Δ {m}_{R} ( p , i , s ; t ) = - {a}_{m} ( p , i , s ; t ) \frac{\partial }{\partial t} {μ}_{a} ( s ; t ) \\ for p \geq {p}_{a} , all ( s ; t )\end{matrix} \qquad ( 13 )$$

The new connection adds the same contributions to the affected column state variables,

$$\begin{matrix}Δ {c}_{C} ( p , k , j , s ; t ) = r - {a}_{R} ( p , i , s ; t ) \frac{\partial }{\partial t} {μ}_{a} ( s ; t ) \\ Δ {z}_{C} ( p , k , j , s ; t ) = {μ}_{a} ( s ; t ) - s \frac{\partial }{\partial s} {μ}_{a} ( s ; t ) - {a}_{z} ( p , i , s ; t ) \frac{\partial }{\partial t} {μ}_{a} ( s ; t ) \\ Δ {B}_{C} ( p , k , j , s ; t ) = \frac{\partial }{\partial s} {μ}_{a} ( s ; t ) - {a}_{B} ( p , i , s ; t ) \frac{\partial }{\partial t} {μ}_{a} ( s ; t ) \\ Δ {m}_{C} ( p , k , j , s ; t ) = - {a}_{m} ( p , i , s ; t ) \frac{\partial }{\partial t} {μ}_{a} ( s ; t ) \\ for p \geq {p}_{a} , all k , all ( s ; t )\end{matrix} \qquad ( 14 )$$

4.4.2 Egress Queues

An outgoing link serves its egress queues at a constant rate. A problem is the traffic arriving to the egress queues. This traffic has changed by passing through the ingress queues and the switch core. As an approximation, assume that the traffic has not changed. This situation is equivalent to handling ingress queues with row service only, see above.

4.5 The Admission Control Algorithm

The algorithm initializes the state variables c, z, B, and m, as described in Equation Blocks (11)-(12). In order to admit a new connection, the algorithm checks every affected priority level. If all priority levels admit the connection, it is admissible, otherwise not.

In order to check a queue, the algorithm checks it over one or more time intervals t. If no t rejects the connection, and some t admits it, the queue admits the connection over the time interval t, otherwise the queue rejects the connection.

In order to check a queue over a time interval t, the algorithm checks it over one or more values of s for the given t. If some point (s;t) rejects the connection, the time interval rejects it. If no point (s;t) rejects, and some point (s;t) admits the connection, the time interval t admits it.

In order to check a queue at a point (s;t) the algorithm increments the state variables c, z, B, and m, as described in equations (13)-(14). It checks the rate condition last in equations (3). If the rate condition is OK, the algorithm calculates q as described in equation (4). It corrects the loss probability for losses on higher priority levels at the same point as described in equation (10). If the corrected loss probability is sufficiently small, and the buffer B is sufficiently small, and the traffic multiplier m is non-negative, and the rate condition is OK, then the queue admits the connection at point (s;t). If the corrected loss probability is negative, then the queue rejects the connection at point (s;t). Otherwise the queue is indecisive at point (s;t).

If the algorithm admits a new connection, it updates all affected c, z, B, and m. If the algorithm rejects a new connection, it reverts to the previous values of all affected c, z, B, and m.

In order to release an established connection, the algorithm decrements all affected c, z, B, and m by the amounts it added when it admitted the connection.

### 5. EXAMPLES OF LOG MOMENT GENERATING FUNCTIONS

### 5.1 Example 1

### Constant Arrival Rates

The workload in an interval of length t is

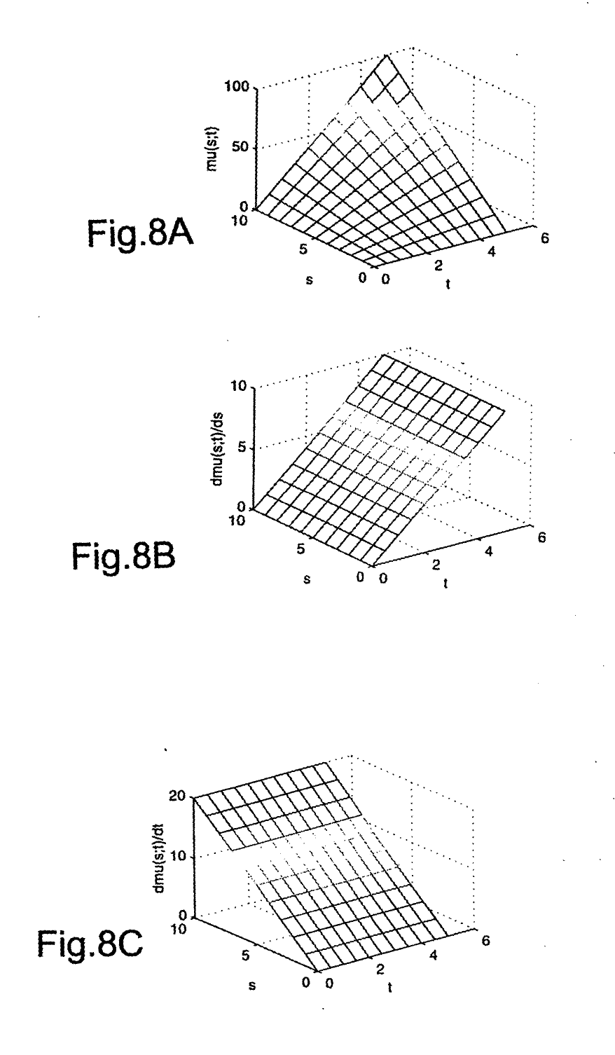

A(t)=Rt

where R is the arrival rate. The log moment generating function (illustrated in FIG. 8A, for constant rate source with R=1) and its derivative with respect to s (illustrated in FIG. 8B) and its derivative with respect to t (illustrated in FIG. 8C) are

$$\begin{matrix}{μ}_{A} ( s ; t ) = log {\int }_{- ∞}^{∞} {ⅇ}^{sx} δ ( x - Rt ) ⅆ x = sRt \\ \frac{ⅆ}{ⅆ s} {μ}_{A} ( s ; t ) = Rt \\ \frac{ⅆ}{ⅆ t} {μ}_{A} ( s ; t ) = sR \\ \frac{{\partial }^{2}}{\partial {s}^{2}} {μ}_{A} ( s ; t ) = 0 \\ \frac{{\partial }^{2}}{\partial s \partial t} {μ}_{A} ( s ; t ) = R \\ \frac{{\partial }^{2}}{\partial {t}^{2}} {μ}_{A} ( s ; t ) = 0\end{matrix}$$

In this case, the asymptotic approximation is exact:

μ_{A}(s;t)=h_{A}(s)t

where h_{A}(s)=s_{R}

The approximation with constant service rate C become

$$\begin{matrix}log {P}_{loss} \approx q \\ \begin{matrix}where & q = - log ( Rst )\end{matrix} \\ \begin{matrix}and & & B = 0\end{matrix} \\ \begin{matrix}and & & C = R - \frac{1}{st}\end{matrix} \\ \begin{matrix}\begin{matrix}for & & s , t > 0 & & and & \end{matrix} & \frac{1}{st} \leq R {ⅇ}^{{q}_{max}}\end{matrix}\end{matrix}$$

This is the case where the bound applies with equality, since f_{W}(x;t) consists of a single delta-impulse at x=(R−C)t=B+1/s, where the exponential curve touches the line y=x−B. In this case, the approximation is exact.

### 5.2 Example 2

### ON-OFF Periodic Fluid Source

The source is ON for Tₒₙ and OFF for T_{off}. The period is Tₒₙ+T_{off}=T. In the ON state, the source generates data at the peak rate

$$R \frac{T}{{T}_{on}} ,$$

and in the OFF state, it generates no data. This is an extreme behavior acceptable by a leaky bucket regulator with mean rate limit R, and bucket size RT_{off}. The phase of this periodic pattern is uniformly distributed in [0,T).

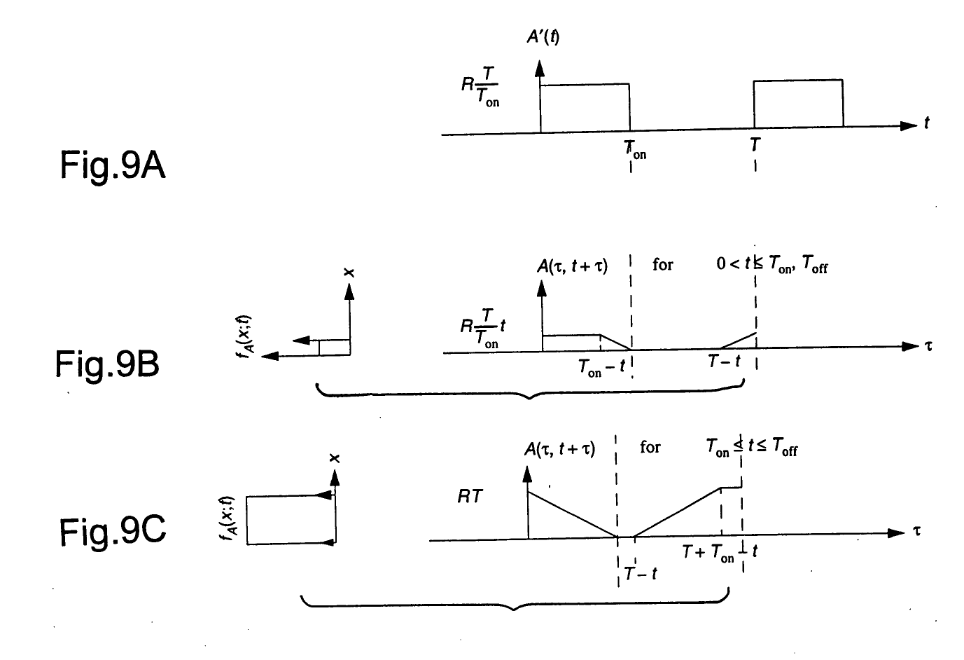

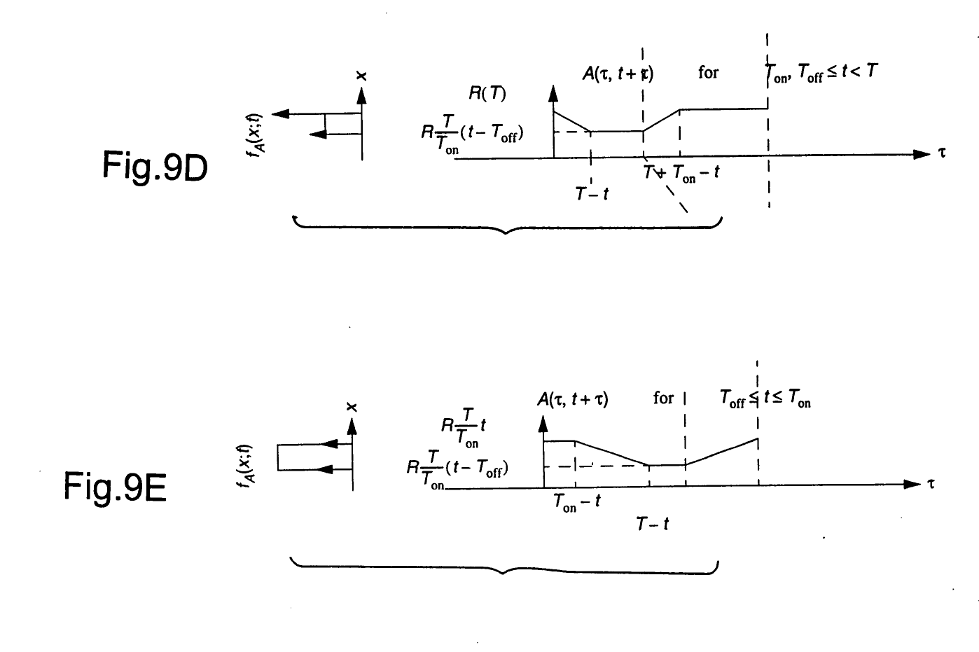

FIG. 9 is a graph showing ON-OFF periodic arrivals. In FIG. 9, A(τ,t+τ) is the amount arriving in [τ,t+τ). The phase τ is uniformly distributed in [0, Tₒₙ+T_{off}). From FIG. 9, it can be seen that the density function of A is the sum of two delta-impulses and a uniform distribution between them.

$$\begin{matrix}{f}_{A} ( x ; t ) = \{ \begin{matrix}δ ( x - nRT ) & for t = nT \\ a δ ( x - {x}_{1} ) + bU ( x ; {x}_{1} , {x}_{2} ) + c δ ( x - {x}_{2} ) & otherwise\end{matrix} \\ where \\ U ( x ; {x}_{1} , {x}_{2} ) = \{ \begin{matrix}\frac{1}{{x}_{2} - {x}_{1}} & for {x}_{1} < x < {x}_{2} \\ 0 & elsewhere\end{matrix}\end{matrix}$$

For t equal to an integer number of periods, this degenerates to a single delta-impulse. For t equal to an integer plus one half number of periods and Tₒₙ=T_{off}, this degenerates to a uniform distribution. Table 1 lists the parameters and their partial derivatives for 0<t<T.

TABLE 1
ON-OFF PERIODIC ARRIVALS, PARAMETER VALUES IN
DENSITY FUNCTION

| | 0 < t ≦ Tₒₙ, | Tₒₙ ≦ | | Tₒₙ, |
|---|---|---|---|---|
| | T_{off} | t ≦ T_{off} | T_{off} ≦ t ≦ Tₒₙ | T_{off} ≦ t < T |
| a | $\frac{{T}_{off} - t}{T}$ | $\frac{{T}_{off} - t}{T}$ | $\frac{t - {T}_{off}}{T}$ | $\frac{t - {T}_{off}}{T}$ |
| x₁ | 0 | 0 | $R \frac{T}{{T}_{on}} ( t - {T}_{off} )$ | $R \frac{T}{{T}_{on}} ( t - {T}_{off} )$ |
| b | $\frac{2 t}{T}$ | $\frac{2 {T}_{on}}{T}$ | $\frac{2 {T}_{off}}{T}$ | $\frac{2 ( T - t )}{T}$ |
| x₂ | $R \frac{T}{{T}_{on}} t$ | RT | $R \frac{T}{{T}_{on}} t$ | RT |
| c | $\frac{{T}_{on} - t}{T}$ | $\frac{t - {T}_{on}}{T}$ | $\frac{{T}_{on} - t}{T}$ | $\frac{t - {T}_{on}}{T}$ |
| $\frac{\partial a}{\partial t}$ | $\frac{- 1}{T}$ | $\frac{- 1}{T}$ | $\frac{1}{T}$ | $\frac{1}{T}$ |
| $\frac{\partial {x}_{1}}{\partial t}$ | 0 | 0 | $R \frac{T}{{T}_{on}}$ | $R \frac{T}{{T}_{on}}$ |
| $\frac{\partial b}{\partial t}$ | $\frac{2}{T}$ | 0 | 0 | $\frac{- 2}{T}$ |
| $\frac{\partial {x}_{2}}{\partial t}$ | $R \frac{T}{{T}_{on}}$ | 0 | $R \frac{T}{{T}_{on}}$ | 0 |
| $\frac{\partial c}{\partial t}$ | $\frac{- 1}{T}$ | $\frac{1}{T}$ | $\frac{- 1}{T}$ | $\frac{1}{T}$ |

For t=nT+αT, 0<α<1 use

f_{A}(x;nT+αT)=f_{A}(x−nRT;αT)

The following auxiliary variables are now introduced:

y=s(x₂−x₁)

z=e^{-y}

$$v = \frac{1 - z}{y}$$

w=az+by+c

with partial derivatives

$$\begin{matrix} & & & \frac{\partial y}{\partial s} = {x}_{2} - {x}_{1} \\ & & & \frac{\partial z}{\partial s} = - {ⅇ}^{- y} \frac{\partial y}{\partial s} \\ & & & \frac{\partial v}{\partial s} = \{ \begin{matrix}\frac{\partial z1}{\partial sy} - \frac{( 1 - z )}{y2} \frac{\partial y}{\partial s} & for y \neq 0 \\ - \frac{1}{2} \frac{\partial y}{\partial s} & for y = 0\end{matrix} \\ & & & \frac{\partial w}{\partial s} = a \frac{\partial z}{\partial s} + b \frac{\partial v}{\partial s} + c \\ and & & & \\ & & & \frac{\partial y}{\partial t} = s ( \frac{\partial {x}_{2}}{\partial t} - \frac{\partial {x}_{1}}{\partial t} ) \\ & & & \frac{\partial z}{\partial t} = - {ⅇ}^{- y} \frac{\partial y}{\partial t} \\ & & & \frac{\partial v}{\partial t} = \{ \begin{matrix}- \frac{\partial z1}{\partial ty} - \frac{( 1 - z )}{y2} \frac{\partial y}{\partial t} & for y \neq 0 \\ - \frac{1}{2} \frac{\partial y}{\partial t} & for y = 0\end{matrix} \\ & & & \frac{\partial w}{\partial t} = \frac{\partial a}{\partial t} z + a \frac{\partial z}{\partial t} + \frac{\partial b}{\partial t} v + b \frac{\partial v}{\partial t} + \frac{\partial c}{\partial t}\end{matrix}$$

The log moment generating function and its derivatives can now be written as

$$\begin{matrix}{μ}_{A} ( s ; nT + α T ) = s ( {x}_{2} + nRT ) + log w \\ \frac{\partial }{\partial s} {μ}_{A} ( s ; nT + α T ) = {x}_{2} + nRT + \frac{1}{w} \frac{\partial w}{\partial s} \\ \frac{\partial }{\partial t} {μ}_{A} ( s ; nT + α T ) = s \frac{\partial {x}_{2}}{\partial t} + \frac{1}{w} \frac{\partial w}{\partial t}\end{matrix}$$

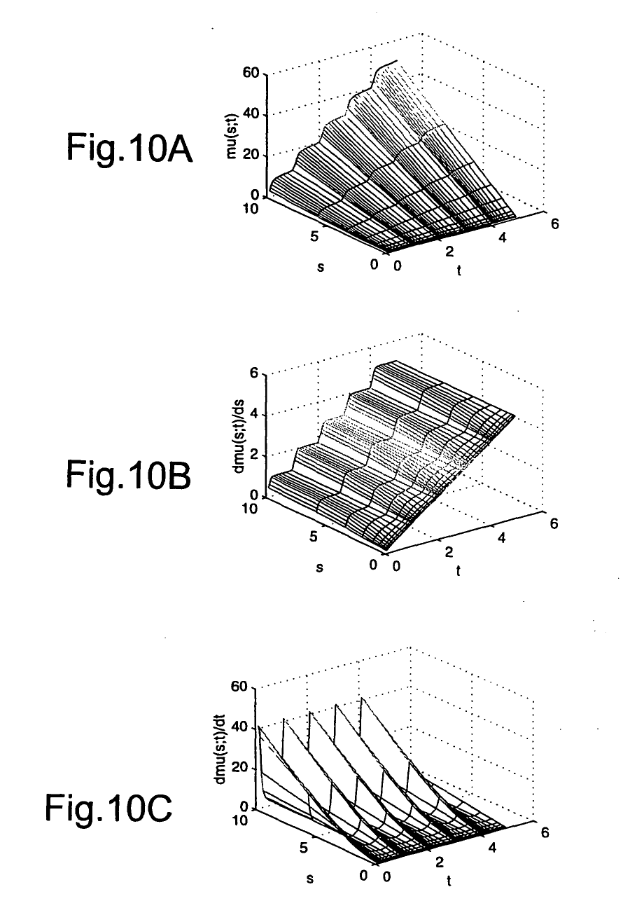

FIG. 10A is a graph showing the Log moment generating function, and FIG. 10B and FIG. 10C its derivatives with respect to s and t, respectively, for ON-OFF periodic source with R=1, T=1, Tₒₙ=0.2.

### 5.3 Example 3

### Discrete Periodic Arrivals

An amount of RT arrives at times t=nT+αT, where n is integer and αε [0,1) is constant. The phase αT is uniformly distributed in [0,T).

In an interval of length t=nT+αT arrives an amount A(t) of either (n+1)RT or nRT,

P(A(nT+αT)=nRT)=1−α

P(A(nT+αT)=(n+1)RT)=α

The log moment generating function, its derivatives, and the asymptotic log moment generating functions are

$$\begin{matrix}{μ}_{A} ( s ; nT + α T ) = sR ( n + 1 ) T + log ( ( 1 - α ) {ⅇ}^{- sRT} + α \\ \frac{\partial }{\partial s} {μ}_{A} ( s ; nT + α T ) = R ( n + 1 ) T - \frac{RT ( 1 - α ) {ⅇ}^{- sRT}}{( 1 - α ) {ⅇ}^{- sRT} + α} \\ \frac{\partial }{\partial t} {μ}_{A} ( s ; nT + α T ) = \frac{1}{T} \frac{1 - {ⅇ}^{- sRT}}{( 1 - α ) {ⅇ}^{- sRT} + α} \\ \frac{{\partial }^{2}}{\partial {s}^{2}} {μ}_{A} ( s ; nT + α T ) = \frac{α {R}^{2} {T}^{2} ( 1 - α ) {ⅇ}^{- sRT}}{{( ( 1 - α ) {ⅇ}^{- sRT} + α )}^{2}} \\ \frac{{\partial }^{2}}{\partial t \partial s} {μ}_{A} ( s ; nT + α T ) = \frac{R {ⅇ}^{- sRT}}{{( ( 1 - α ) {ⅇ}^{- sRT} + α )}^{2}} \\ \frac{{\partial }^{2}}{\partial {t}^{2}} {μ}_{A} ( s ; nT + α T ) = - \frac{{( 1 - {ⅇ}^{- sRT} )}^{2}}{{{T}^{2} ( ( 1 - α ) {ⅇ}^{- sRT} + α )}^{2}} \\ {h}_{A} ( s ) = sR\end{matrix}$$

Notice that the asymptotic log moment generating function is the same as for a constant rate process. Using this, the asymptotic log moment generating function in the approximations is thus equivalent to using a constant rate model of the arrival process.

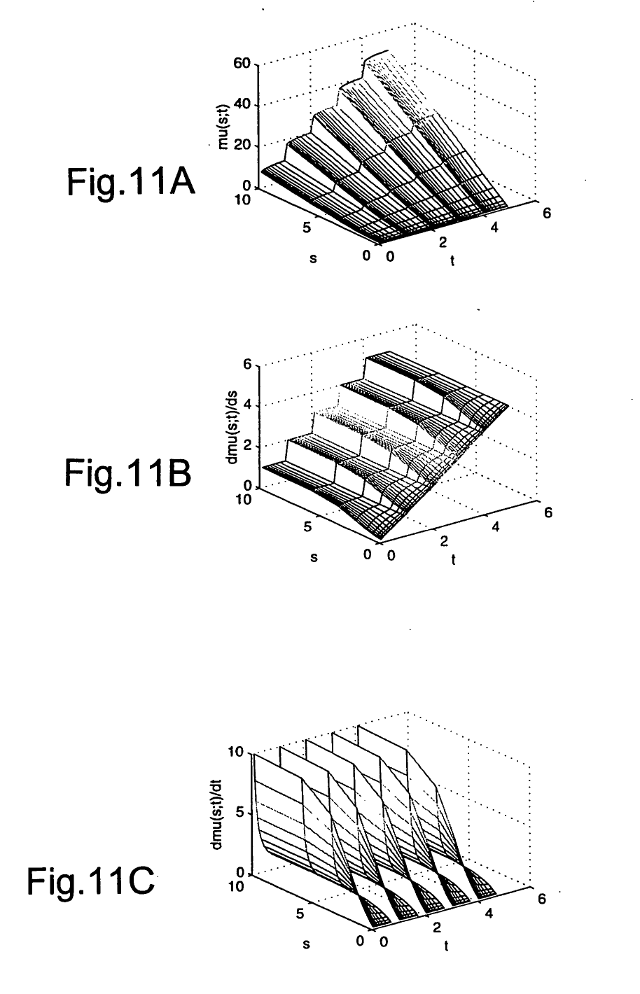

FIG. 11A is a graph showing the log moment generating function, and FIG. 11B and FIG. 11C are graphs showing the derivatives of the log moment generation function of FIG. 11A with respect to s and t, respectively, for discrete periodic source with T=1, R=1.

### 5.4 Example 4

### Poisson Arrivals

The mean interval time is T. Each arrival contributes an amount of RT. The probability of k arrivals in time t is (e^{-t/T}(t/T)^{k})/k!. The log moment generating function and its derivatives of the arrival process are (as explained in A. Papoulis, “Probability, Random Values, and Stochastic Processes”, McGraw-Hill, 1965),

$$\begin{matrix}{μ}_{A} ( s ; t ) = \frac{t}{T} ( {ⅇ}^{sRT} - 1 ) \\ \frac{ⅆ}{ⅆ s} {μ}_{A} ( s ; t ) = Rt {ⅇ}^{sRT} \\ \frac{ⅆ}{ⅆ t} {μ}_{A} ( s ; t ) = \frac{1}{T} ( {ⅇ}^{sRT} - 1 ) \\ \frac{{ⅆ}^{2}}{ⅆ {s}^{2}} {μ}_{A} ( s ; t ) = {R}^{2} Tt {ⅇ}^{sRT} \\ \frac{{ⅆ}^{2}}{ⅆ s ⅆ t} {μ}_{A} ( s ; t ) = R {ⅇ}^{sRT} \\ \frac{{ⅆ}^{2}}{ⅆ {t}^{2}} {μ}_{A} ( s ; t ) = 0\end{matrix}$$

Also in this case, the asymptotic approximation is exact:

μ_{A}(s;t)=h_{A}(s)t

where h_{A}(s)=(e^{sRT}−1))/T

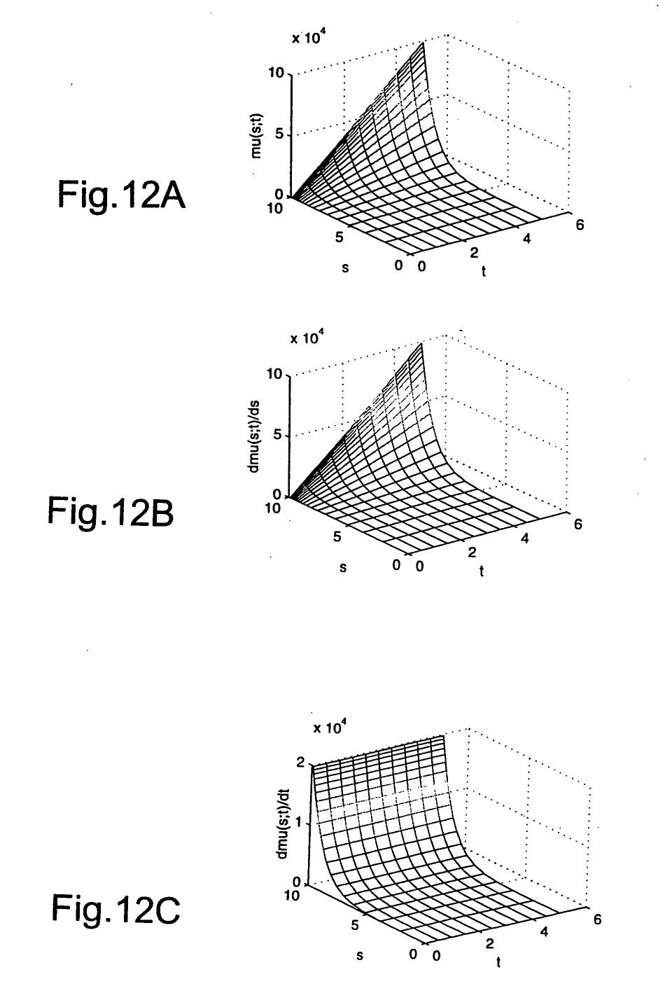

FIG. 12A is a graph showing the log moment generating function, and FIG. 12B and FIG. 12C are graphs showing the derivatives of the log moment generation function of FIG. 12A with respect to s and t, respectively, for a Poisson source with T=1, R=1.

### 5.5 Example 5

### Markov Fluid Arrival Process

A source is called a Markov fluid if its time-derivative is a function of a continuous-time Markov chain on a finite state space. Let 1, . . . , m be the state space and

Q_{A}=[qᵢⱼ] the irreducible transition rate matrix

qᵢⱼ the transition rate from state i to another state j

$${q}_{ii} = - {\sum }_{j \neq i} {q}_{ij}$$

minus the sum of transition rates from state i

π=(π₁, . . . , πₘ) the row vector of steady-state probabilities, is the solution of πQ_{A}=0 and π1=1

R_{A}=diag(R₁, . . . , Rₘ) diagonal matrix of arrival rates

Rᵢ arrival rate in state i

1 a column of 1's

λ(X) The largest real eigenvalue of a matrix X

The log moment generating function (see Kesidis et al, “Effective Bandwidths for Multiclass Markov Fluids and Other ATM Sources”, IEEE Trans. Networking, Vol. 1, No. 4, pp. 424-428, August 1993), and its partial derivatives and asymptotic log moment generating function are

$$\begin{matrix}{μ}_{A} ( s ; t ) = log ( π {ⅇ}^{( {Q}_{A} + {sR}_{A} ) t} 1 ) \\ \frac{\partial }{\partial s} {μ}_{A} ( s ; t ) = \frac{1}{π {ⅇ}^{( {Q}_{A} + {sR}_{A} ) tt} 1} π ( \frac{\partial }{\partial s} {ⅇ}^{( {Q}_{A} + {sR}_{A} ) t} ) 1 \\ \frac{\partial }{\partial t} {μ}_{A} ( s ; t ) = \frac{1}{π {ⅇ}^{( {Q}_{A} + {sR}_{A} ) t} 1} π ( {Q}_{A} + {sR}_{A} ) {ⅇ}^{( {Q}_{A} + {sR}_{A} ) t} 1 \\ {h}_{A} ( s ) = λ ( {Q}_{A} + {sR}_{A} )\end{matrix}$$

The partial derivative with respect to s is not simple in general. To find it, diagonalize

Q_{A}+sR_{A}=V(s)D(s)V⁻¹(s)

where D(s) is a diagonal matrix of eigenvalues of Q_{A}+sR_{A}

and V(s) is a matrix of column eigenvectors

Now use

$${ⅇ}^{( {Q}_{A} + {sR}_{A} ) t} = {ⅇ}^{{VDV}^{- 1}} = {\sum }_{n = 0}^{∞} \frac{{t}^{n}}{n !} {VD}^{n} {V}^{- 1}$$

and find after some calculation

$$\begin{matrix}\frac{\partial }{\partial s} {ⅇ}^{( {Q}_{A} + {sR}_{A} ) t} = \frac{ⅆ V}{ⅆ s} {V}^{- 1} {ⅇ}^{( {Q}_{A} + {sR}_{A} ) t} + {ⅇ}^{( {Q}_{A} + {sR}_{A} ) t} V \frac{ⅆ D}{ⅆ s} {V}^{- 1} t - \\ {ⅇ}^{( {Q}_{A} + {sR}_{A} ) t} \frac{ⅆ V}{ⅆ s} {V}^{- 1}\end{matrix}$$

5.5.1 HIGH/LOW Rate Source

A HIGH/LOW rate source is a special case with two states,

$$\begin{matrix}{Q}_{A} = [ \begin{matrix}- {Q}_{1 , 2} & {Q}_{1 , 2} \\ {Q}_{2 , 1} & - {Q}_{2 , 1}\end{matrix} ] ( transitions \text{/} s ) \\ {R}_{A} = [ \begin{matrix}{R}_{1} & 0 \\ 0 & {R}_{2}\end{matrix} ] ( bit \text{/} s )\end{matrix}$$

and an ON/OFF source is special case of this with R₂=0.

The steady state probabilities of the source are

$$π = [ \frac{{Q}_{2 , 1}}{{Q}_{1 , 2} + {Q}_{2 , 1}} \frac{{Q}_{1 , 2}}{{Q}_{1 , 2} + {Q}_{2 , 1}} ]$$

Direct calculation gives the eigenvalues

$$\begin{matrix}{h}_{A} ( s ) = {λ}_{1} = \frac{1}{2} ( - a + \sqrt{{a}^{2} - 4 b} ) \\ {λ}_{2} = \frac{1}{2} ( - a - \sqrt{{a}^{2} - 4 b} ) \\ where a = {Q}_{1 , 2} + {Q}_{2 , 1} - s ( {R}_{2} + {R}_{1} ) \\ and b = {s}^{2} {R}_{2} {R}_{1} - s ( {Q}_{1 , 2} {R}_{2} + {Q}_{2 , 1} {R}_{1} )\end{matrix}$$

Diagonal eigenvalues and column eigenvectors matrices are

$$\begin{matrix}D ( s ) = [ \begin{matrix}{λ}_{1} & 0 \\ 0 & {λ}_{2}\end{matrix} ] \\ V ( s ) = [ \begin{matrix}{Q}_{1 , 2} & {Q}_{1 , 2} \\ {Q}_{1 , 2} - {sR}_{1} + {λ}_{1} & {Q}_{1 , 2} - {sR}_{1} + {λ}_{2}\end{matrix} ]\end{matrix}$$

Derivatives with respect to s are

$$\begin{matrix}\frac{ⅆ D}{ⅆ s} = [ \begin{matrix}\frac{ⅆ {λ}_{1}}{ⅆ s} & 0 \\ 0 & \frac{ⅆ {λ}_{2}}{ⅆ s}\end{matrix} ] \\ \frac{ⅆ V}{ⅆ s} = [ \begin{matrix}0 & 0 \\ - {R}_{1} + \frac{ⅆ {λ}_{1}}{ⅆ s} & - {R}_{1} + \frac{ⅆ {λ}_{2}}{ⅆ s}\end{matrix} ] \\ where \frac{ⅆ {λ}_{1}}{ⅆ s} = \frac{- \frac{ⅆ a}{ⅆ s} + ( a \frac{ⅆ a}{ⅆ s} - 2 \frac{ⅆ b}{ⅆ s} )}{2 \sqrt{{a}^{2} - 4 b}} \\ and \frac{ⅆ {λ}_{2}}{ⅆ s} = \frac{- \frac{ⅆ a}{ⅆ s} - ( a \frac{ⅆ a}{ⅆ s} - 2 \frac{ⅆ b}{ⅆ s} )}{2 \sqrt{{a}^{2} - 4 b}} \\ and where \frac{ⅆ a}{ⅆ s} = - {R}_{2} - {R}_{1} \\ and \frac{ⅆ b}{ⅆ s} = 2 {sR}_{1} {R}_{2} - {Q}_{1 , 2} {R}_{2} - {Q}_{2 , 1} {R}_{1}\end{matrix}$$

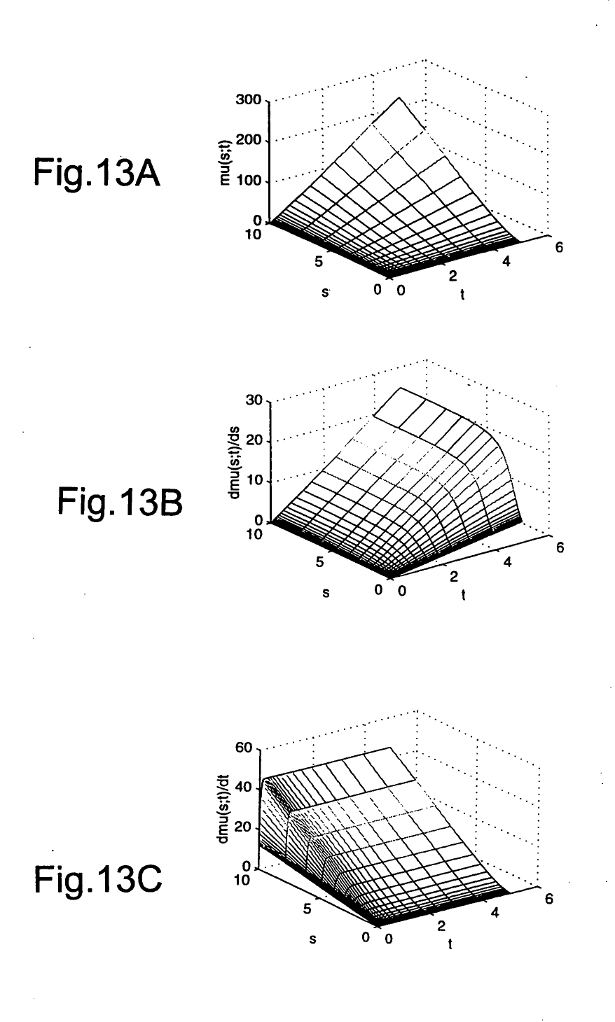

FIG. 13A is a graph showing the log moment generating function, and FIG. 13B and FIG. 13C are graphs showing the derivatives of the log moment generation function of FIG. 13A with respect to s and t, respectively, for an ON/OFF Markov fluid source with T=1/Q_{1,2}+1/Q_{2,1}=1, Tₒₙ=1/Q_{1,2}=0.2, R=1.

5.6 Always ON or OFF Fluid Arrival Process

This is a limiting case of a process with very heavy tails on the holding time distributions. The source is ON always with probability P_{ON}, generating data at rate R/P_{ON}, or it is OFF always with probability P_{OFF}=1−P_{ON}, generating no data. The probability density function of the amount of data received in time t is

$${f}_{A} ( x ; t ) = {P}_{OFF} δ ( x ) + {P}_{ON} δ ( x - \frac{R}{{P}_{ON}} t )$$

The log moment generating function and its derivatives are

$$\begin{matrix}{μ}_{A} ( s ; t ) = log ( {P}_{OFF} + {P}_{ON} {ⅇ}^{s \frac{R}{{P}_{ON}} t} ) \\ \frac{\partial }{\partial s} {μ}_{A} ( s ; t ) = \frac{Rt}{{P}_{OFF} {ⅇ}^{- s \frac{R}{{P}_{ON}} t} + {P}_{ON}} \\ \frac{\partial }{\partial t} {μ}_{A} ( s ; t ) = \frac{sR}{{P}_{OFF} {ⅇ}^{- s \frac{R}{{P}_{ON}} t} + {P}_{ON}} \\ \frac{{\partial }^{2}}{\partial {s}^{2}} {μ}_{A} ( s ; t ) = \frac{\frac{{P}_{OFF}}{{P}_{ON}} {R}^{2} {t}^{2} {ⅇ}^{- \frac{sRt}{{P}_{ON}}}}{{( {P}_{OFF} {ⅇ}^{- \frac{sRt}{{P}_{ON}}} + {P}_{ON} )}^{2}} \\ \frac{{\partial }^{2}}{\partial s \partial t} {μ}_{A} ( s ; t ) = R \frac{{P}_{OFF} {ⅇ}^{- \frac{sRt}{{P}_{ON}}} + {P}_{ON} + sRt \frac{{P}_{OFF}}{{P}_{ON}} {ⅇ}^{- \frac{sRt}{{P}_{ON}}}}{{( {P}_{OFF} {ⅇ}^{- \frac{sRt}{{P}_{ON}}} + {P}_{ON} )}^{2}} \\ \frac{{\partial }^{2}}{\partial {t}^{2}} {μ}_{A} ( s ; t ) = \frac{\frac{{P}_{OFF}}{{P}_{ON}} {R}^{2} {s}^{2} {ⅇ}^{- \frac{sRt}{{P}_{ON}}}}{{( {P}_{OFF} {ⅇ}^{- \frac{sRt}{{P}_{ON}}} + {P}_{ON} )}^{2}}\end{matrix}$$

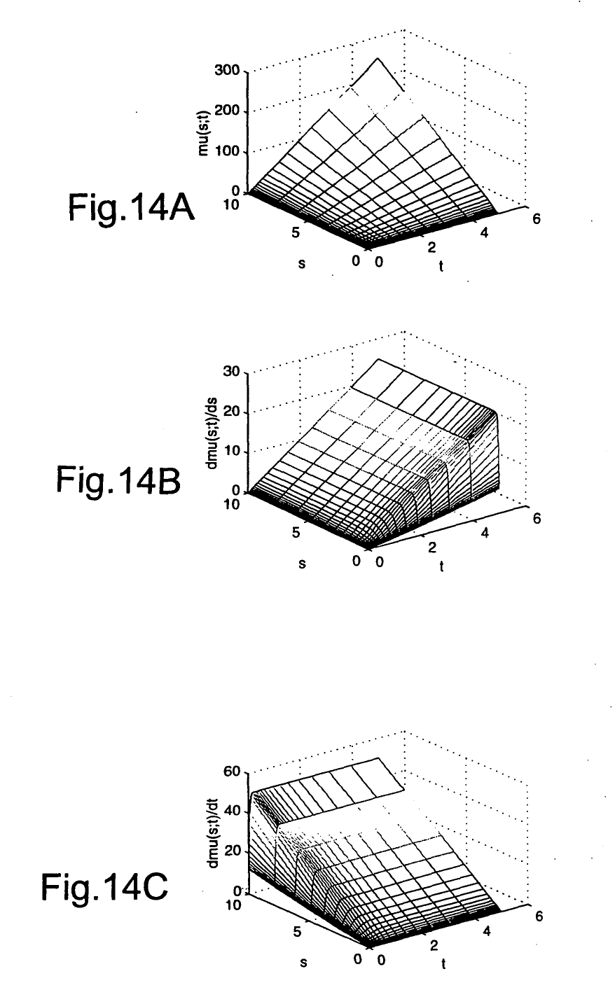

FIG. 14A is a graph showing the log moment generating function, and FIG. 14B and FIG. 14C are graphs showing the derivatives of the log moment generation function of FIG. 14A with respect to s and t, respectively, for always ON or OFF fluid source with P_{ON}=0.2 and R=1.

6 Examples of Loss, Buffer, and Bandwidth Consumption

This section defines some traffic classes spanning a wide range of bandwidth and burstiness. It uses traffic cases spanning a wide range of link loads to illustrate regions of (s,t) admitting or rejecting a traffic case. Table 2 lists traffic classes.

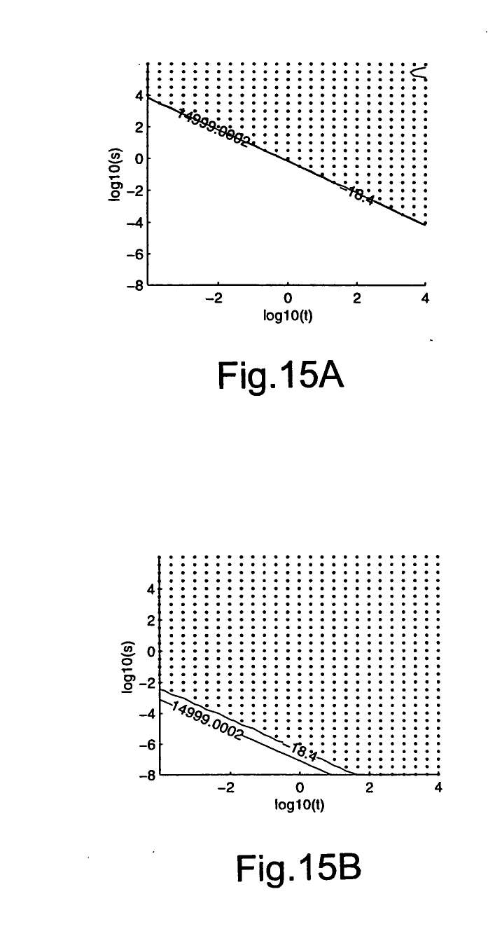

FIG. 15A-FIG. 30B show contours of q=ln 10⁻⁸=−18.4, B=3 Mbit, and m=0 bit/s, and m=mₘₐₓ, for differing traffic cases and the region(s) bounded by these contours admitting or rejecting the particular traffic case. FIG. 15A-FIG. 30B assume a link bandwidth of C₀=150 Mbit/s. The typical traffic used is the actual traffic itself unless otherwise stated.

TABLE 2
Traffic Classes

| Class | | Average rate, | Average | Probability of |
|---|---|---|---|---|
| ID | Source model | R (bit/s) | period, T(s) | ON, P_{ON} |
| 1 | Constant rate | 10⁴ | | |
| 2 | ON-OFF periodic | 10⁴ | 0.01 | 0.01 |
| 3 | Discrete periodic | 10⁴ | 0.01 | |
| 4 | ON-OFF Markov | 10⁴ | 0.01 | 0.01 |
| 5 | Poisson | 10⁴ | 0.01 | |
| 6 | ON-OFF periodic | 10⁴ | 100 | 0.01 |
| 7 | Discrete periodic | 10⁴ | 100 | |
| 8 | ON-OFF Markov | 10⁴ | 100 | 0.01 |
| 9 | Poisson | 10⁴ | 100 | |
| 10 | Always ON or | 10⁴ | | 0.01 |
| | OFF | | | |
| 11 | ON-OFF periodic | 10⁷ | 0.01 | 0.1 |
| 12 | Discrete periodic | 10⁷ | 0.01 | |
| 13 | ON-OFF Markov | 10⁷ | 0.01 | 0.1 |
| 14 | Poisson | 10⁷ | 0.01 | |
| 15 | ON-OFF periodic | 10⁷ | 100 | 0.1 |
| 16 | Discrete Periodic | 10⁷ | 100 | |
| 17 | ON-OFF Markov | 10⁷ | 100 | 0.1 |
| 18 | Poisson | 10⁷ | 100 | |
| 19 | Always ON or | 10⁷ | | 0.1 |
| | OFF | | | |

Table 3 lists numbers traffic cases with one connection.

TABLE 3

| Case ID | Description |
|---|---|
| 1 | 1 Class 1 |
| 2 | 1 Class 2 |
| 3 | 1 Class 3 |
| 4 | 1 Class 4 |
| 5 | 1 Class 5 |
| 6 | 1 Class 6 |
| 7 | 1 Class 7 |
| 8 | 1 Class 8 |
| 9 | 1 Class 9 |
| 10 | 1 Class 10 |
| 11 | 1 Class 11 |
| 12 | 1 Class 12 |
| 13 | 1 Class 13 |
| 14 | 1 Class 14 |
| 15 | 1 Class 15 |
| 16 | 1 Class 16 |
| 17 | 1 Class 17 |
| 18 | 1 Class 18 |
| 19 | 1 Class 19 |

FIG. 15A illustrates the foregoing one connection traffic case 1; FIG. 15B illustrates one connection traffic case 10. Both FIG. 15A and FIG. 15B show contours of q, B, and m, for one connection, average rate 10 kbit/s. FIG. 15A shows case 1 (constant rate); FIG. 15B shows case 10 (always ON or OFF, P_{ON}=0.01). No B>3 Mbit is found for m<mₘₐₓ; no m<0 is found for m<mₘₐₓ.

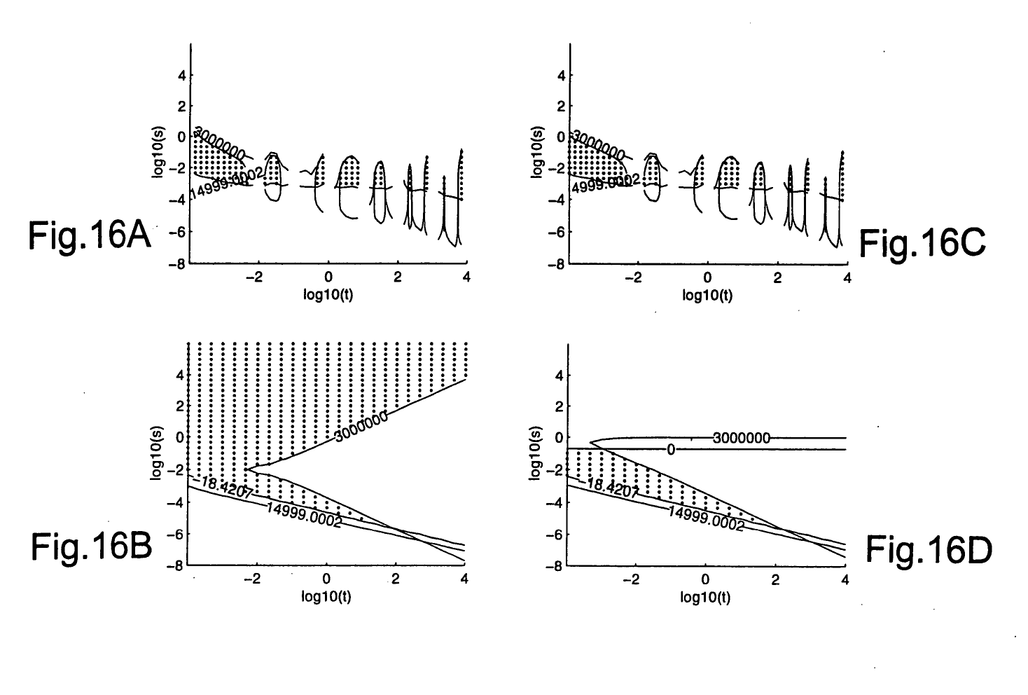

FIG. 16A-FIG. 16D illustrate traffic cases 2, 3,4, 5, (showing contours of q, B, and m) for one connection, average rate 10 kbit/s, average period 10 ms. FIG. 16A shows case 2 (ON-OFF periodic, P_{ON}=0.01); FIG. 16B shows case 3 (discrete periodic); FIG. 16C shows case 4 (ON-OFF Markov, P_{ON}=0.01); and FIG. 16D shows case 5 (Poisson).

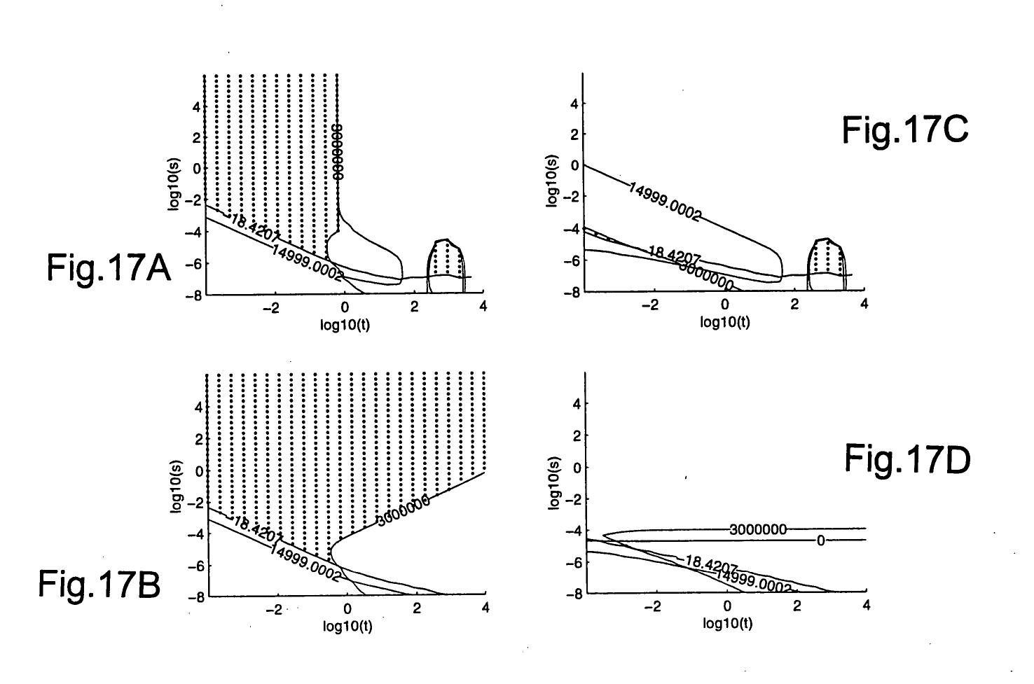

FIG. 17A-FIG. 17B illustrate traffic cases 6, 7, 8, 9 (showing contours of q, B, and m) for one connection, average rate 10 kbit/s, average period 10 s. FIG. 17A shows case 6 (ON-OFF periodic, P_{ON}=0.01); FIG. 17B shows case 7 (discrete periodic); FIG. 17C shows case 8 (ON-OFF Markov, P_{ON}=0.01); and FIG. 17D shows case 9 (Poisson).

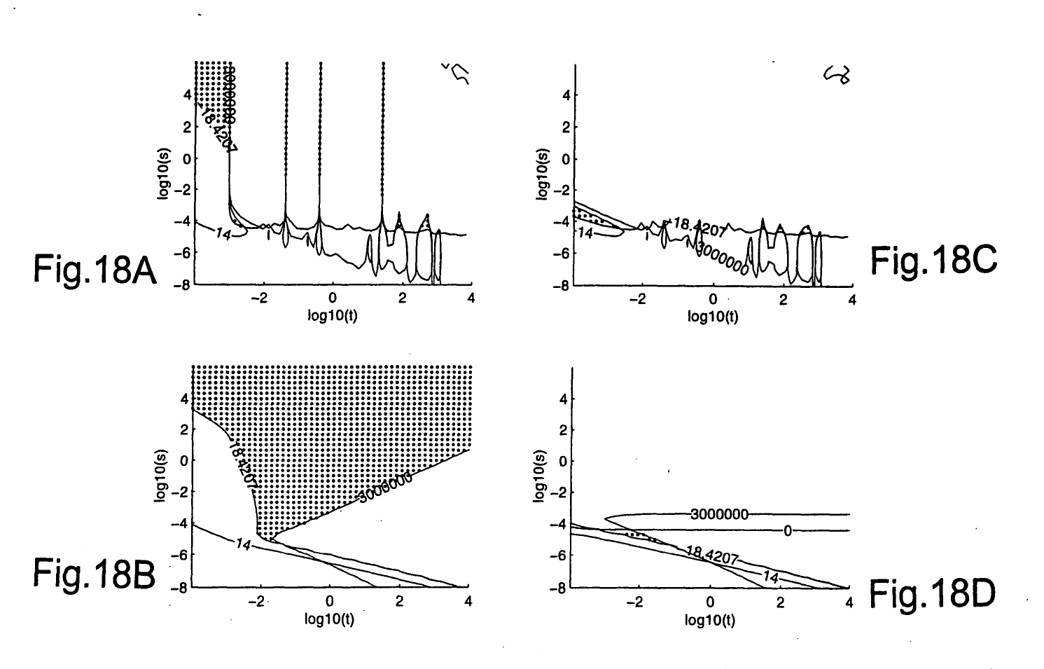

FIG. 18A-FIG. 18D illustrate traffic cases 11, 12, 13, 14 (showing contours of q, B, and m) for one connection, average rate 10 kbit/s, average period 10 ms. FIG. 18A shows case 11 (ON-OFF periodic, P_{ON}=0.01); FIG. 18B shows case 12 (discrete periodic); FIG. 18C shows case 13 (ON-OFF Markov, P_{ON}=0.01); FIG. 18D shows case 14 (Poisson).

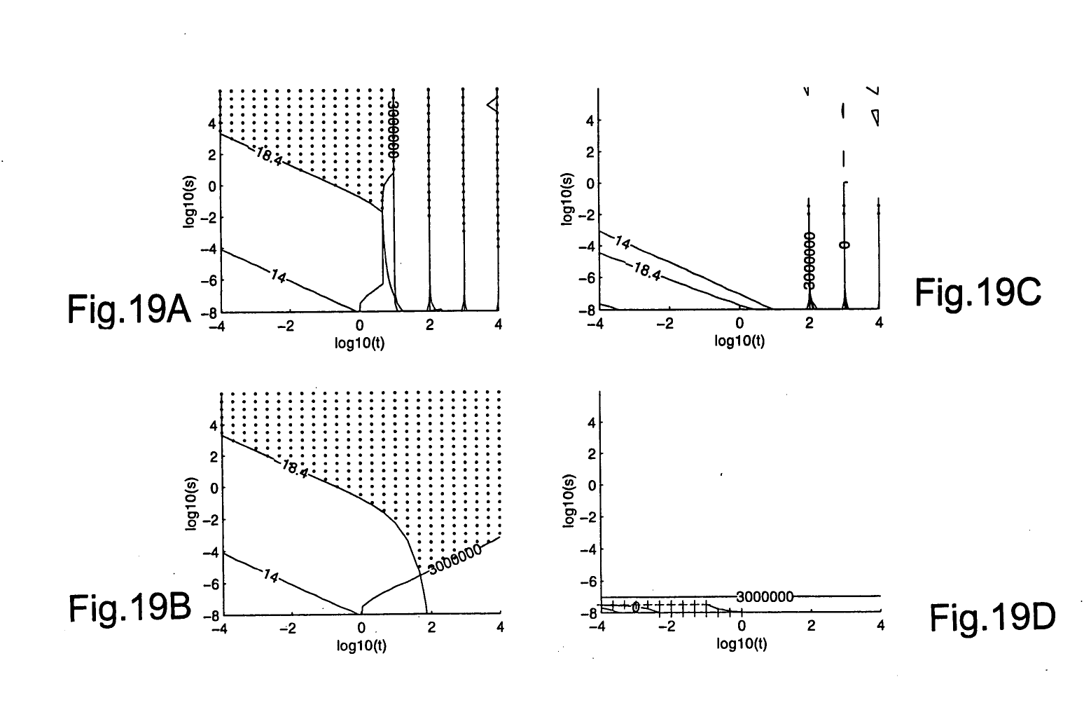

FIG. 19A-FIG. 19D illustrate traffic cases 15, 16, 17, 18 (showing contours of q, B, and m) one connection, average rate 10 kbit/s, average period 10 s. FIG. 19A shows case 15 (ON-OFF periodic, P_{ON}=0.01); FIG. 19B shows case 16 (discrete periodic); FIG. 19C shows case 17 (ON-OFF Markov, P_{ON}=0.01); FIG. 19D shows case 18 (Poisson). Traffic case 16 of FIG. 19B is clearly inadmissible. A burst of 1 Gbit arrives instantaneously to a buffer of size 3 Mbit, which looses 99.7% of the arriving data. Yet Equation Block (3) admits the connection at some points (s,t) with t>1 period=100 s. The reason for this is that the workload over long periods looks acceptable, while it is unacceptable over short periods (see also FIG. 1). The global maximum of q occurs in the first period of t. The admitting points found are at local maxima in later periods and thus false solutions. The conclusion of this is that one must choose the working point (s,t) for periodic traffic within the first period. Another peculiarity of traffic case 16, is that no working point (s,t) is able to reject the case. In the region below the contour labeled “−18.4” in FIG. 19B, q and B are far from admissible, while m is close to 0; but m>0 everywhere.

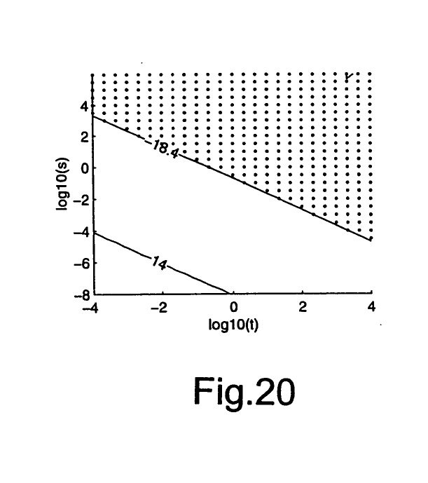

FIG. 20 illustrates traffic case 19 (showing contours of q, B, and m) for one connection average rate 10 Mbit/s. Case 19 is always ON or OFF, P_{ON}=01.

Table 4 lists numbers traffic cases (cases 20-38) with the maximum number of connections from a single traffic class admitted by Equation Block (3).

TABLE 4

| Case ID | Description |
|---|---|
| 20 | 15000 Class 1 |
| 21 | 14999 Class 2 |
| 22 | 14999 Class 3 |
| 23 | 14996 Class 4 |
| 24 | 14998 Class 5 |
| 25 | 10409 Class 6 |
| 26 | 84 Class 7 |
| 27 | 10342 Class 8 |
| 28 | 81 Class 9 |
| 29 | 9508 Class 10 |
| 30 | 14 Class 11 |
| 31 | 14 Class 12 |
| 32 | 9 Class 13 |
| 33 | 11 Class 14 |
| 34 | 1 Class 15 |
| 35 | 0 Class 16 |
| 36 | 1 Class 17 |
| 37 | 0 Class 18 |
| 38 | 1 Class 19 |

Table 5 lists numbers traffic cases (cases 39-57) with the minimum number of connections from a single traffic class not admitted by Equation Block (3).

TABLE 5

| Case ID | Description |
|---|---|
| 39 | 15001 Class 1 |
| 40 | 15000 Class 2 |
| 41 | 15000 Class 3 |
| 42 | 14997 Class 4 |
| 43 | 14999 Class 5 |
| 44 | 10410 Class 6 |
| 45 | 85 Class 7 |
| 46 | 10343 Class 8 |
| 47 | 82 Class 9 |
| 48 | 9509 Class 10 |
| 49 | 15 Class 11 |
| 50 | 15 Class 12 |
| 51 | 10 Class 13 |
| 52 | 12 Class 14 |
| 53 | 2 Class 15 |
| 54 | 1 Class 16 |
| 55 | 2 Class 17 |
| 56 | 1 Class 18 |
| 57 | 2 Class 19 |

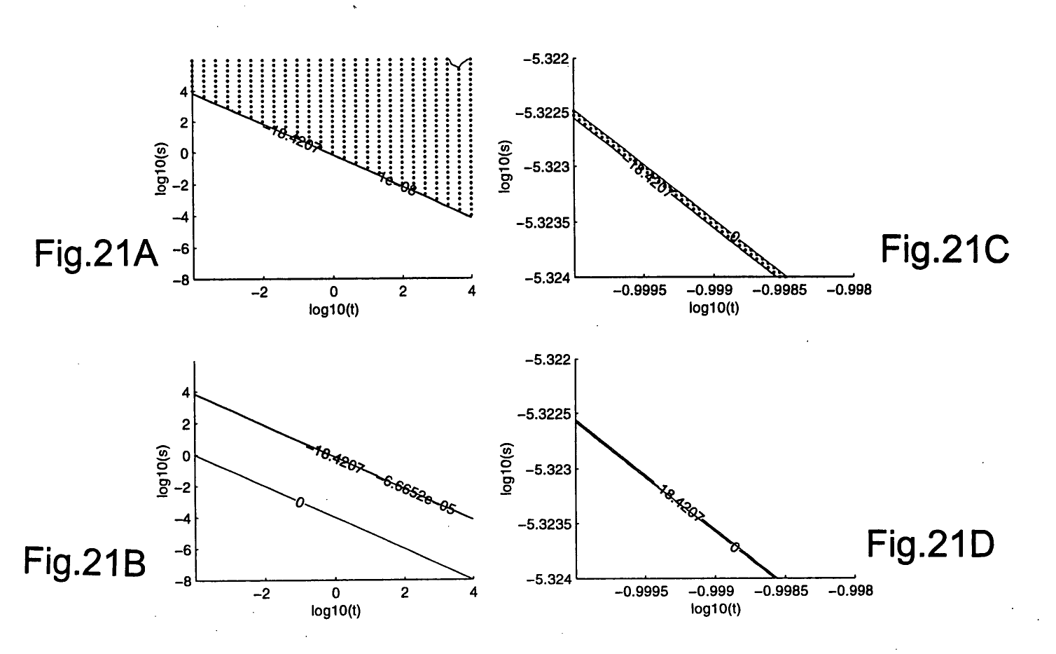

FIG. 21A-FIG. 21D illustrate traffic cases 20, 29, 39, 48 (again showing contours of Contours of q, B, and m), with maximum admissible and minimum inadmissible numbers of connections, average rate 10 kbit/s. FIG. 21A shows case 20 (constant rate, 15000 connections); FIG. 21B shows case 29 (always ON or OFF, P_{ON}=0.01, 9508 connections); FIG. 21C shows case 39 (constant rate, 15001 connections); FIG. 21D shows case 48 (always ON or OFF, P_{ON}=0.01, 9509 connections).

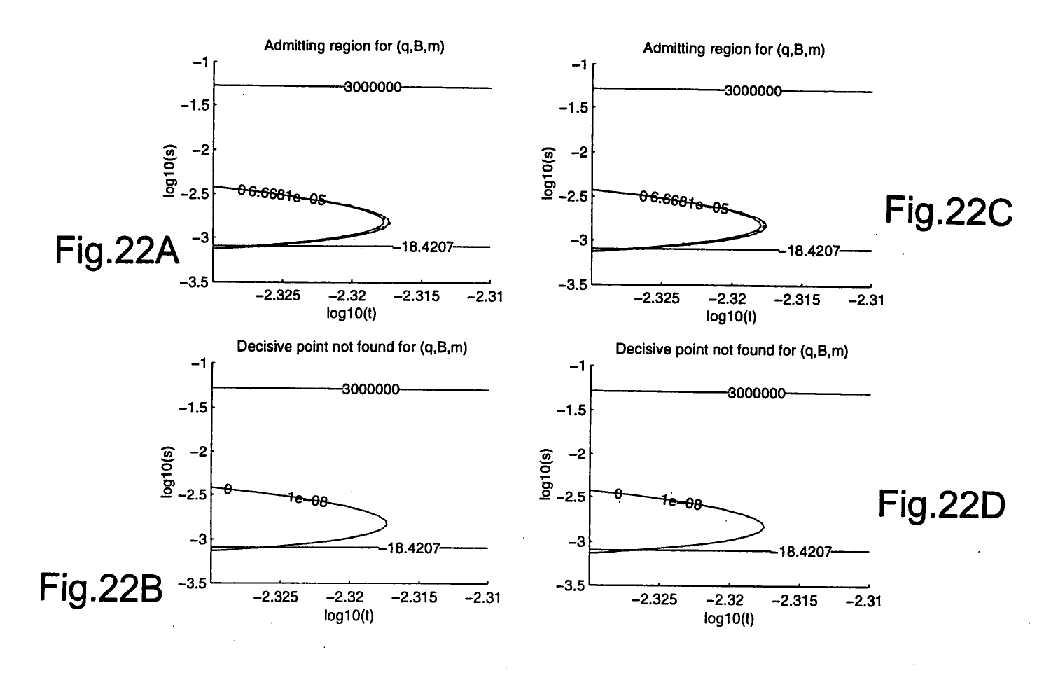

FIG. 22A-FIG. 22D illustrate traffic cases 21, 22, 40, 41 (again showing contours of q, B, and m) for maximum admissible and minimum inadmissible numbers of connections, average rate 10 kbit/s, average period 10 ms. FIG. 22A shows case 21 (ON-OFF periodic, P_{ON}=0.01, 14999 connections); FIG. 22B shows case 22 (discrete periodic, 14999 connections); FIG. 22C shows case 40 (ON-OFF periodic, P_{ON}=0.01, 15000 connections); FIG. 22D shows case 24 (Poisson, 15000 connections). In FIG. 22 there is no difference between the ON-OFF periodic and discrete periodic models of approximately the same type of connections. This is because the burst size 100 bit is much smaller than the buffer size 3 Mbit.

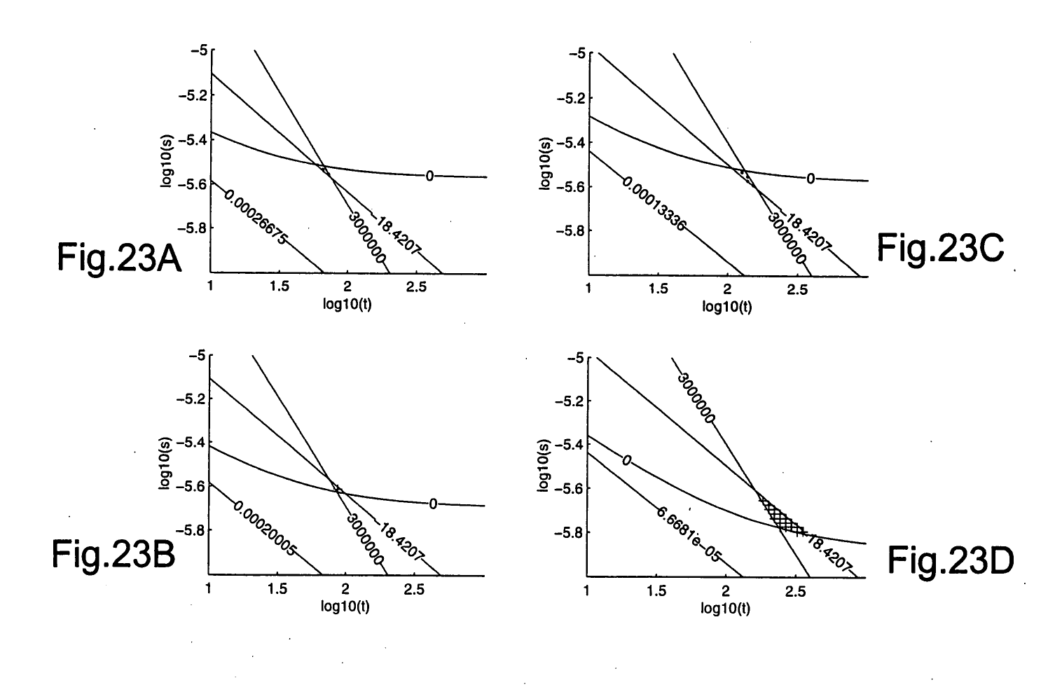

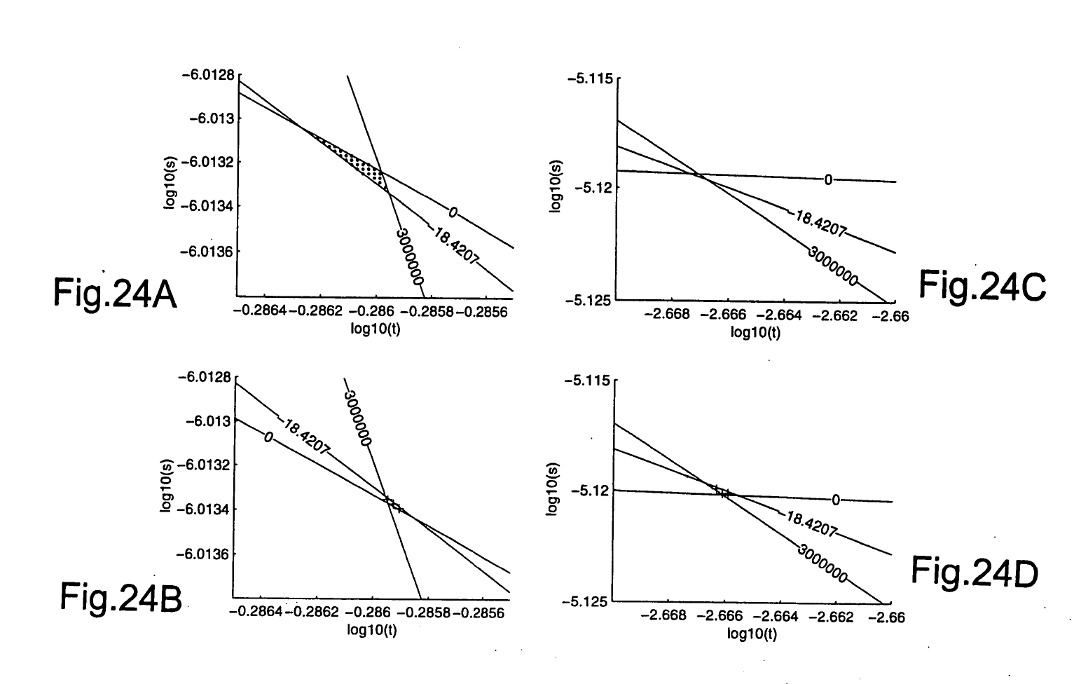

FIG. 23A-FIG. 23D illustrate traffic cases 23, 24, 42, 43 (again showing contours of q, B, and m) for maximum admissible and minimum inadmissible numbers of connections, average rate 10 kbit/s, average period 10 ms. FIG. 23A shows case 23 (ON-OFF Markov, P_{ON}=0.01, 14996 connections); FIG. 23B shows case 24 (Poisson, 14998 connections); FIG. 23C shows case 42 (ON-OFF Markov, P_{ON}=0.01, 14997 connections); FIG. 24D shows case 43 (Poisson, 14999 connections).

FIG. 24A-FIG. 24D illustrate traffic cases 25, 26, 44, 45 (again showing contours of q, B, and m) for maximum admissible and minimum inadmissible numbers of connections, average rate 10 kbit/s, average period 100 s. FIG. 24A shows case 25 (ON-OFF periodic, P_{ON}=0.01, 10409 connections); FIG. 24B shows case 26 (discrete periodic, 84 connections); FIG. 24C shows case 44 (ON-OFF periodic, P_{ON}=0.01, 10410 connections); FIG. 24D shows case 45 (discrete period, 85 connections). In FIG. 24 there is a great difference between the ON-OFF periodic and discrete periodic models of approximately the same type of connections. This is because the burst size 1 Mbit is of the same order of magnitude as the buffer size 3 Mbit.

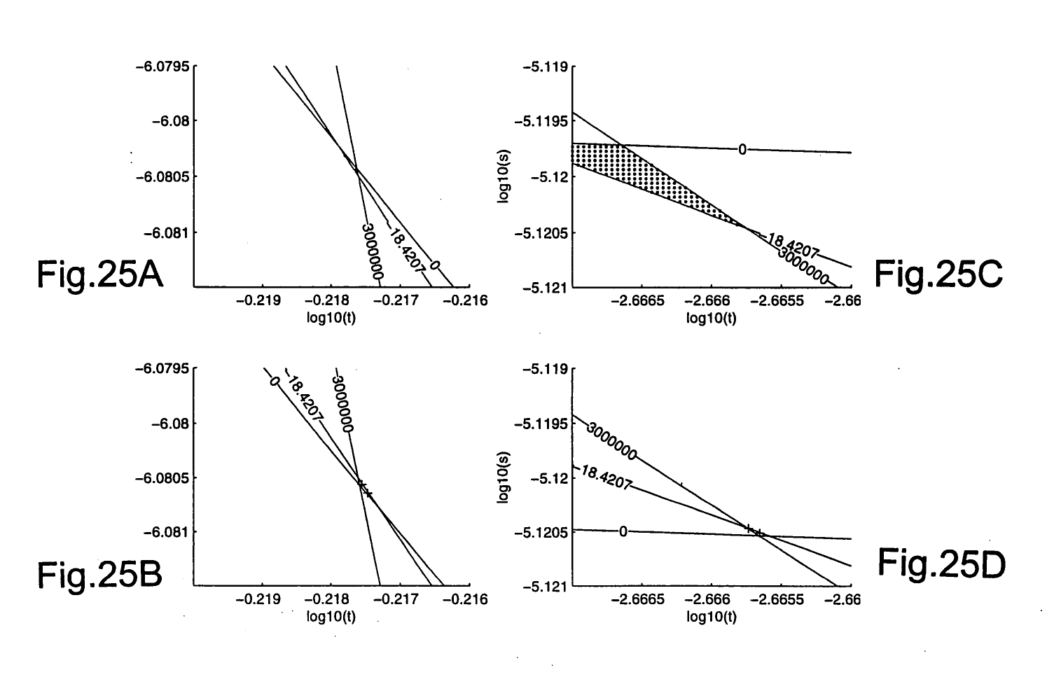

FIG. 25A-FIG. 25D illustrate traffic cases 27, 28, 46, 47 (again for contours of q, B, and m) for maximum admissible and minimum inadmissible numbers of connections, average rate 10 kbit/s, average period 100 s. FIG. 25A shows case 27 (ON-OFF Markov, P_{ON}=0.01, 10342 connections); FIG. 25B shows case 28 (Poisson, 81 connections); FIG. 25C shows case 46 (ON-OFF Markov, P_{ON}=0.01, 10343 connections); FIG. 25D shows case 47 (Poisson, 82 connections).

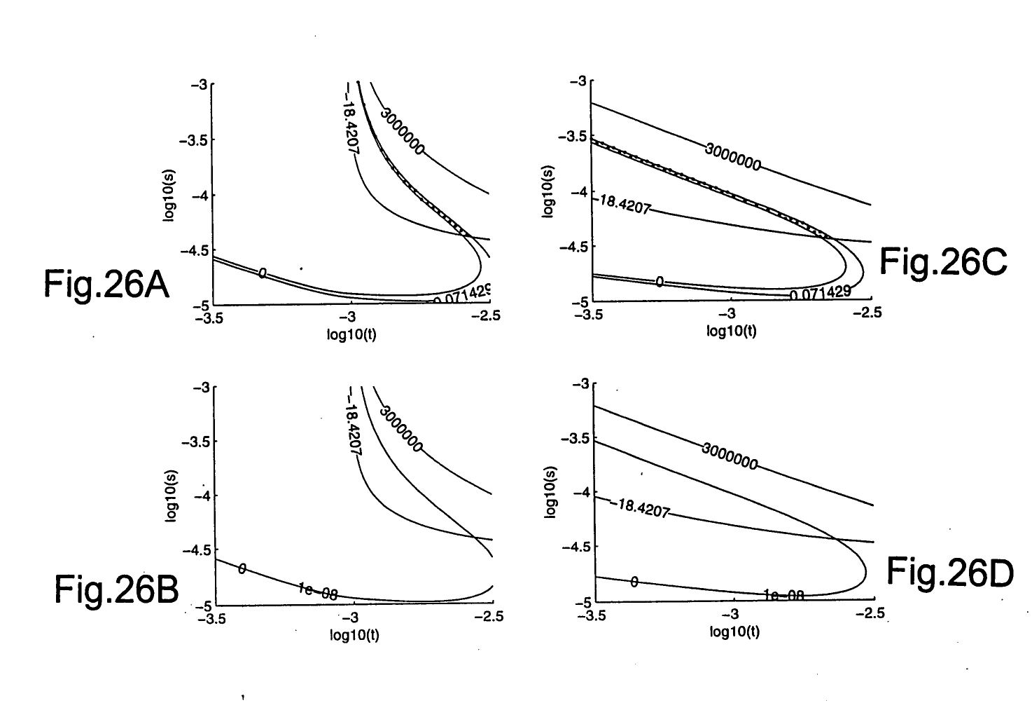

FIG. 26A-FIG. 26D illustrate traffic cases 30, 31, 49, 50 (again showing contours of q, B, and m) for maximum admissible and minimum inadmissible numbers of connections, average rate 10 kbit/s, average period 10 ms. FIG. 26A shows case 30 (ON-OFF periodic, P_{ON}=0.01, 14 connections); FIG. 26B shows case 31 (discrete periodic, 14 connections); FIG. 26C shows case 49 (ON-OFF periodic, P_{ON}=0.01, 15 connections); FIG. 26D shows case 50 (discrete period, 15 connections).

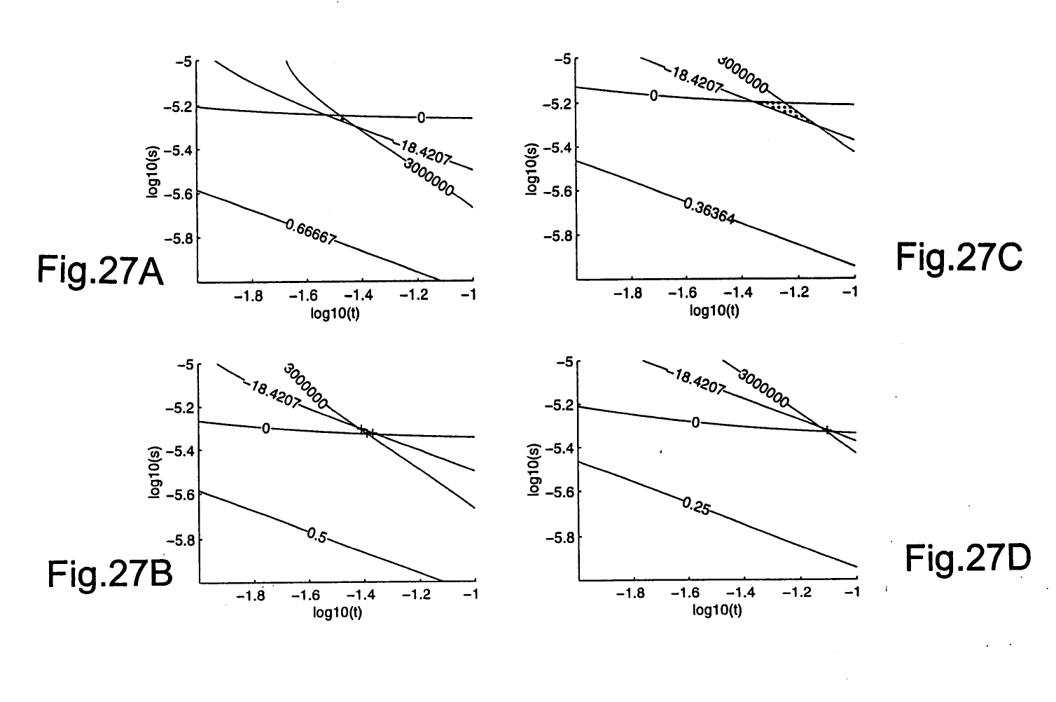

FIG. 27A-FIG. 27B illustrate traffic cases 32, 33, 51, 52 (again for contours of q, B, and m) for maximum admissible and minimum inadmissible numbers of connections, average rate 10 Mbit/s, average period 10 ms. FIG. 27A shows case 32 (ON-OFF Markov, P_{ON}=0.01, 9 connections); FIG. 27B shows case 33 (Poisson, 11 connections); FIG. 27C shows case 51 (ON-OFF Markov, P_{ON}=0.01, 10 connections); FIG. 27D shows case 52 (Poisson, 12 connections

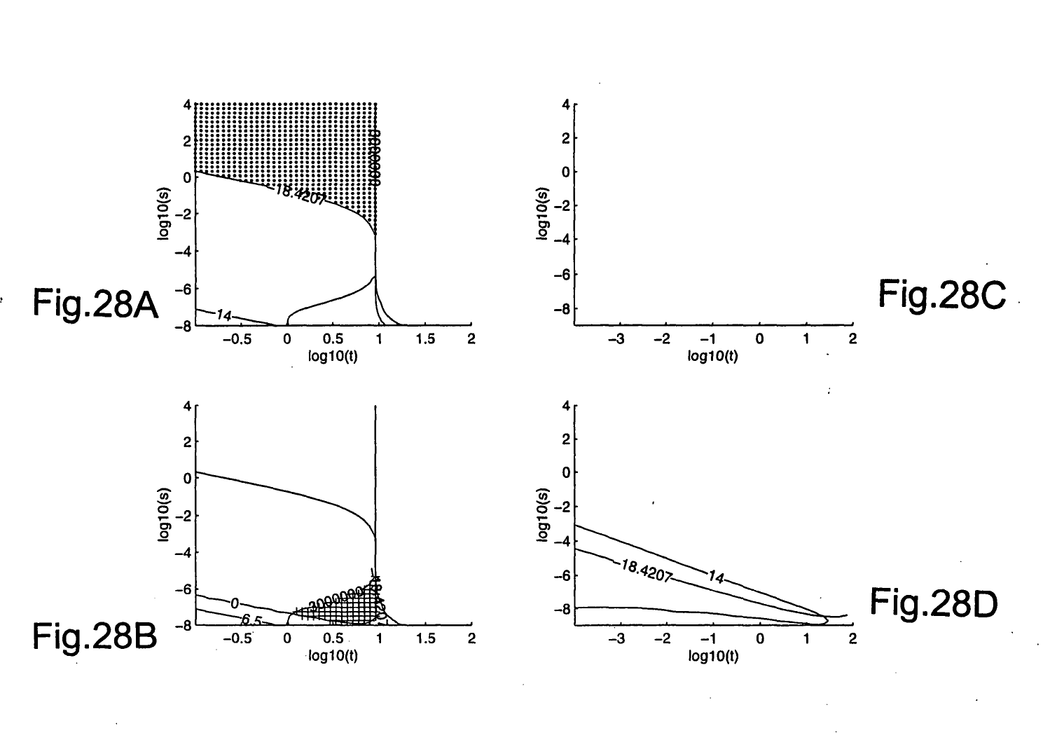

FIG. 28A-FIG. 28D illustrate traffic cases 34, 35, 53, 54 (showing contours of q, B, and m) for maximum admissible and minimum inadmissible numbers of connections, average rate 10 Mbit/s, average period 100 s. FIG. 28A shows case 34 (ON-OFF periodic, P_{ON}=0.01, 1 connection); FIG. 28B shows case 35 (discrete periodic, 0 connections); FIG. 28C shows case 53 (ON-OFF periodic, P_{ON}=0.01, 2 connections); FIG. 28D shows case 54 (discrete period, 1 connection; same as case 16; no B<=3 Mbit and no m<=0 found)

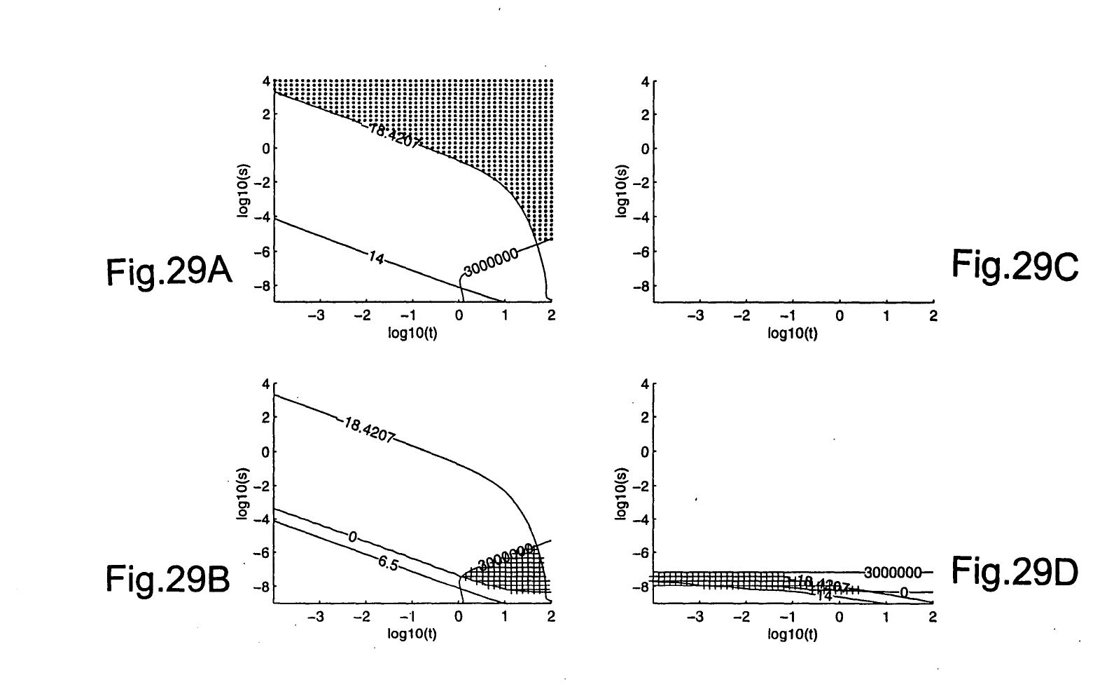

FIG. 29A-FIG. 29D illustrate traffic cases 36, 37, 55, 56 (showing contours of q, B, and m) for maximum admissible and minimum inadmissible numbers of connections, average rate 10 Mbit/s, average period 100 s. FIG. 29A shows case 36 (ON-OFF Markov, P_{ON}≅0.01, 1 connection; same as case 17); FIG. 29B shows case 37 (Poisson, 0 connections); FIG. 29C shows case 55 (ON-OFF Markov, P_{ON}≅0.1, 2 connections); FIG. 29D shows case 56 (Poisson; same as case 18).

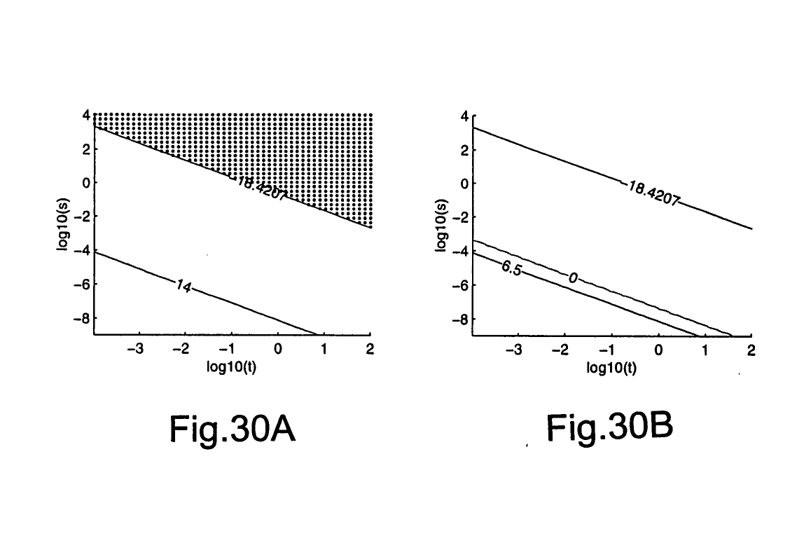

FIG. 30A-FIG. 30B illustrate traffic cases 38, 57 (showing contours of q, B, and m) for maximum admissible and minimum inadmissible numbers of connections, average rate 10 Mbit/s, always ON or OFF, P_{ON}=0.1 FIG. 30A shows case 38, 1 connection; same as case 19); FIG. 30B shows case 57 (2 connections).

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A node of a telecommunications network which performs a connection admission control (CAC) operation with respect to a new connection by making a determination of log loss ratio and buffer size for a queue having real traffic and imaginary traffic, the connection admission control (CAC) operation admitting the new connection if (1) the determination of log loss is acceptable; (2) the buffer size is acceptable; and (3) the imaginary traffic contribution is non-negative.

2. The apparatus of claim 1, wherein the imaginary traffic is a multiple of a pre-determined set of connections.

3. The apparatus of claim 1, wherein the connection admission control (CAC) operation uses the following four state variables:
(1) a linear term z(s,t) in an approximation to the log loss ratio at a working point (s,t);
(2) an argument c(s,t) of a logarithmic term in the approximation to the log loss ratio at working point (s,t);
(3) a buffer limit B(s,t) used at the working point (s,t); and
(4) a multiplier m(s,t) of the imaginary traffic used at the working point (s,t).

4. The apparatus of claim 3, wherein a value for at least one of the four state variables depends upon an evaluation of a log moment generating function.

5. The apparatus of claim 3, wherein a value for at least one of the four state variables depends upon an evaluation of a log moment generating function and two partial derivatives of the log moment generating function of workload of the queue over a time interval.

6. The apparatus of claim 3, wherein the working point (s,t) is picked from a set of candidate working points as performing well with a particular design traffic mix.

7. The apparatus of claim 1, wherein the determination is made at a predetermined working point.

8. The apparatus of claim 7, wherein the predetermined working point is picked from a set of candidate working points as performing well with a particular design traffic mix.

9. The apparatus of claim 1, wherein, with respect to a new connection, the connection admission control (CAC) operation, at at least one working point, determines whether to admit new traffic by:
(1) making plural determinations, the plural determinations including:
(a) a determination of a log loss approximation q;
(b) a determination of a buffer limit B; and
(c) a determination of a multiplier m of design traffic;
(2) maintaining plural state variables initialized to respective initialization values, the plural state variables being used to make the determinations of (1); and
(3) adding increments to the four state variables for the new connection.

10. The apparatus of claim 9, wherein the plural state variables are:
(1) a linear term z(s,t) in an approximation to the log loss ratio at a working point (s,t);
(2) an argument c(s,t) of a logarithmic term in the approximation to the log loss ratio at working point (s,t);
(3) a buffer limit B(s,t) used at the working point (s,t); and
(4) a multiplier m(s,t) of the imaginary traffic used at the working point (s,t).

11. The apparatus of claim 10, wherein the log loss approximation is q=z−log c.

12. The apparatus of claim 10, wherein the four state variables are maintained at the following respective initialization values:
$$\begin{matrix} & c ( s , t ) = {a}_{c} ( s ; t ) ( Cs + \frac{1}{t} ) \\ & z ( s ; t ) = {a}_{z} ( s ; t ) ( Cs + \frac{1}{t} ) - log ( st ) \\ & B ( s ; t ) = - Ct + {a}_{B} ( s ; t ) ( Cs + \frac{1}{t} ) - \frac{1}{s} \\ & m ( s ; t ) = {a}_{m} ( s ; t ) ( Cs + \frac{1}{t} ) \\ where & \\ & {a}_{c} ( s ; t ) = \frac{{R}_{o}}{\frac{\partial }{\partial t} {μ}_{0} ( s ; t )} \\ & {a}_{z} ( s ; t ) = \frac{{μ}_{0} ( s ; t ) - s \frac{\partial }{\partial s} {μ}_{0} ( s ; t )}{\frac{\partial }{\partial t} {μ}_{0} ( s ; t )} \\ & {a}_{B} ( s ; t ) = \frac{\frac{\partial }{\partial s} {μ}_{0} ( s ; t )}{\frac{\partial }{\partial t} {μ}_{0} ( s ; t )} \\ & {a}_{m} ( s ; t ) = \frac{1}{\frac{\partial }{\partial t} {μ}_{0} ( s ; t )}\end{matrix} \qquad ( 1 )$$
where
R₀ is a mean rate of design traffic;
μ₀(s;t) is a log moment generating function of design traffic;
$$\frac{\partial }{\partial s} {μ}_{0} ( s ; t )$$
is a partial derivative with respect to s, design traffic;
$$\frac{\partial }{\partial t} {μ}_{0} ( s ; t )$$
is a partial derivative with respect to t, design traffic;
C is a constant service rate.

13. The apparatus of claim 11, wherein the following increments are added to the four state variables for the new connection:
$$\begin{matrix}Δ c ( s ; t ) = r - {a}_{c} ( s ; t ) \frac{\partial }{\partial t} {μ}_{a} ( s ; t ) \\ Δ z ( s ; t ) = {μ}_{a} ( s ; t ) - s \frac{\partial }{\partial s} {μ}_{a} ( s ; t ) - {a}_{z} ( s ; t ) \frac{\partial }{\partial t} {μ}_{a} ( s ; t ) \\ Δ {B}_{R} ( s ; t ) = \frac{\partial }{\partial s} {μ}_{a} ( s ; t ) - {a}_{B} ( s ; t ) \frac{\partial }{\partial t} {μ}_{a} ( s ; t ) \\ Δ {m}_{R} ( s ; t ) = - {a}_{m} ( s ; t ) \frac{\partial }{\partial t} {μ}_{a} ( s ; t )\end{matrix} \qquad ( 2 )$$
where
r is a mean rate of the new connection;
μ_{α}(s; t) is a log moment generating function of arrival of the new connection;
$$\frac{\partial }{\partial s} {μ}_{a} ( s ; t )$$
Partial derivative with respect to s, new connection
$$\frac{\partial }{\partial t} {μ}_{a} ( s ; t )$$
is a partial derivative with respect to t, new connection.

14. The apparatus of claim 10, wherein the connection admission control (CAC) operation subtracts the increments of (3) when the new connection is cleared.

15. The apparatus of claim 9, wherein the connection admission control (CAC) operation determines to admit the new connection if all the following are true:
q is less than or equal to the log loss ratio required by the quality of service (QOS) of the traffic;
B is less than or equal to the limit set by available buffer space and QOS delay requirements;
m is non-negative; and
R+mR₀−C≦(R+mR₀)e^{q}^{ₘₐₓ}
where
R is a mean rate of all real connections, including the new connection;
qₘₐₓ is a log loss ratio required by the QOS of the traffic.

16. The apparatus of claim 10, wherein a set of plural state variables is maintained for each of plural priority levels of connections, each of the plural priority levels having an associated queue.

17. The apparatus of claim 16, wherein the connection admission control operation treats high priority level queue as if lower priority traffic did not exist.

18. The apparatus of claim 16, wherein the connection admission control operation treats a low priority queue as being offered a sum of traffic on the low priority level and all higher priority levels.

19. The apparatus of claim 16, wherein the queues of the plural priority levels share a common buffer space of limited size, and wherein the log loss ratio in a lower priority queue is checked according to the following loss rate inequality:
Re^{q}−R_{H}e^{q}^{_{H}}≦R_{L}e^{q}^{ₘₐₓ} (3)
wherein
R_{L} is a mean rate of traffic through the lower priority queue;
q_{Lmax} is a log loss ratio required by the traffic through the lower priority queue;
R_{H} is a mean rate of traffic through all higher priority queues together;
q_{H} is a log loss ratio of traffic through all higher priority queues together;
R is a mean rate of traffic through the lower priority queue and all higher priority queues together; and
q is a log loss ratio of traffic through the lower priority queue and all higher priority queues together.

20. The apparatus of claim 16, wherein the node has plural servers in series, wherein the plural queues are treated as if served by only one of the servers at a time, each server maintaining a set of the plural state variables, and wherein the connection admission control operation decides to admit the new connection if a slowest server admits the new connection.

21. A connection admission control method for a node of a telecommunications system, the method comprising:
(I) making a determination of log loss ratio and buffer size for a queue having real traffic and imaginary traffic;
(II) admitting a new connection if (1) the determination of log loss ratio is acceptable; (2) the buffer size is acceptable; and (3) the imaginary traffic contribution is non-negative.

22. The method of claim 21, wherein the imaginary traffic is a multiple of a pre-determined set of connections.

23. The method of claim 21, further comprising using the following four state variables in either of step (I) or step (II):
(1) a linear term z(s,t) in an approximation to the log loss ratio at a working point (s,t);
(2) an argument c(s,t) of a logarithmic term in the approximation to the log loss ratio at working point (s,t);
(3) a buffer limit B(s,t) used at the working point (s,t); and
(4) a multiplier m(s,t) of the imaginary traffic used at the working point (s,t).

24. The method of claim 23, wherein a value for at least one of the four state variables depends upon an evaluation of a log moment generating function.

25. The method of claim 23, wherein a value for at least one of the four state variables depends upon an evaluation of a log moment generating function and two partial derivatives of the log moment generating function of workload the queue over a time interval.

26. The method of claim 23, further comprising picking the working point (s,t) from a set of candidate working points as performing well with a particular design traffic mix.

27. The method of claim 23, further comprising making the determination of step (I) is made at a predetermined working point.

28. The method of claim 27, further comprising picking the predetermined working point is picked from a set of candidate working points as performing well with a particular design traffic mix.

29. The method of claim 21, further comprising, determining whether to admit new traffic by:
(1) making plural determinations, the plural determinations including:
(a) a determination of a log loss approximation q;
(b) a determination of a buffer limit B; and
(c) a determination of a multiplier m of design traffic;
(2) maintaining plural state variables initialized to respective initialization values, the plural state variables being used to make the determinations of (1); and
(3) adding increments to the four state variables for the new connection.

30. The method of claim 29, wherein the plural state variables are:
(1) a linear term z(s,t) in an approximation to the log loss ratio at a working point (s,t);
(2) an argument c(s,t) of a logarithmic term in the approximation to the log loss ratio at working point (s,t);
(3) a buffer limit B(s,t) used at the working point (s,t); and
(4) a multiplier m(s,t) of the imaginary traffic used at the working point (s,t).

31. The method of claim 30, wherein the log loss approximation is q=z−log c.

32. The method of claim 30, further comprising maintaining the four state variables at the following respective initialization values:
$$\begin{matrix}c ( s ; t ) = {a}_{c} ( s ; t ) ( Cs + \frac{1}{t} ) \\ z ( s ; t ) = {a}_{z} ( s ; t ) ( Cs + \frac{1}{t} ) - log ( st ) \\ B ( s ; t ) = - Ct + {a}_{B} ( s ; t ) ( Cs + \frac{1}{t} ) - \frac{1}{s} \\ m ( s ; t ) = {a}_{m} ( s ; t ) ( Cs + \frac{1}{t} )\end{matrix} \qquad ( 1 )$$
where
$$\begin{matrix}{a}_{c} ( s ; t ) = \frac{{R}_{o}}{\frac{\partial }{\partial t} {μ}_{0} ( s ; t )} \\ {a}_{z} ( s ; t ) = \frac{{μ}_{0} ( s ; t ) - s \frac{\partial }{\partial s} {μ}_{0} ( s ; t )}{\frac{\partial }{\partial t} {μ}_{0} ( s ; t )} \\ {a}_{B} ( s ; t ) = \frac{\frac{\partial }{\partial s} {μ}_{0} ( s ; t )}{\frac{\partial }{\partial t} {μ}_{0} ( s ; t )} \\ {a}_{m} ( s ; t ) = \frac{1}{\frac{\partial }{\partial t} {μ}_{0} ( s ; t )}\end{matrix}$$
where
R₀ is a mean rate of design traffic;
μ₀(s;t) is a log moment generating function of design traffic;
$$\frac{\partial }{\partial s} {μ}_{0} ( s ; t )$$
is a partial derivative with respect to s, design traffic;
$$\frac{\partial }{\partial t} {μ}_{0} ( s ; t )$$
′is a partial derivative with respect to t, design traffic;
C is a constant service rate.

33. The method of claim 30, wherein the following increments are added to the four state variables for the new connection:
$$\begin{matrix}\begin{matrix}\begin{matrix}Δ c ( s ; t ) = r - {a}_{c} ( s ; t ) \frac{\partial }{\partial t} {μ}_{a} ( s ; t ) \\ Δ z ( s ; t ) = {μ}_{a} ( s ; t ) - s \frac{\partial }{\partial t} {μ}_{a} ( s ; t ) - {a}_{z} ( s ; t ) \frac{\partial }{\partial t} {μ}_{a} ( s ; t )\end{matrix} \\ Δ {B}_{R} ( s ; t ) = \frac{\partial }{\partial s} {μ}_{a} ( s ; t ) - {a}_{B} ( s ; t ) \frac{\partial }{\partial t} {μ}_{a} ( s ; t )\end{matrix} \\ Δ {m}_{R} ( s ; t ) = - {a}_{m} ( s ; t ) \frac{\partial }{\partial t} {μ}_{a} ( s ; t )\end{matrix} \qquad ( 2 )$$
where
r is a mean rate of the new connection;
μ_{α}(s; t) is a log moment generating function of arrival of the new connection;
$$\frac{\partial }{\partial s} {μ}_{a} ( s ; t )$$
Partial derivative with respect to s, new connection
$$\frac{\partial }{\partial t} {μ}_{a} ( s ; t )$$
is a partial derivative with respect to t, new connection.

34. The method of claim 29, wherein the connection admission control (CAC) operation subtracts the increments of (3) when the new connection is cleared.

35. The method of claim 29, wherein the connection admission control (CAC) operation determines to admit the new connection if all the following are true:
q is less than or equal to the log loss ratio required by the quality of service (QOS) of the traffic;
B is less than or equal to the limit set by available buffer space and QOS delay requirements;
m is non-negative; and
R+mR₀−C≦(R+mR₀)e^{q}^{ₘₐₓ}
where
R is a mean rate of all real connections, including the new connection;
qₘₐₓ is a log loss ratio required by the QOS of the traffic.

36. The method of claim 29, further comprising maintaining a set of plural state variables for each of plural priority levels of connections, each of the plural priority levels having an associated queue.

37. The method of claim 36, further comprising treating a high priority level queue as if lower priority traffic did not exist.

38. The method of claim 36, further comprising treating a low priority queue as being offered a sum of traffic on the low priority level and all higher priority levels.

39. The method of claim 36, further comprising the queues of the plural priority levels sharing a common buffer space of limited size, and further comprising checking the log loss ratio in a lower priority queue according to the following loss rate inequality:
Re^{q}−R_{H}e^{q}^{_{H}}≦R_{L}e^{q}^{ₘₐₓ} (3)
wherein
R_{L} is a mean rate of traffic through the lower priority queue;
q_{Lmax} is a log loss ratio required by the traffic through the lower priority queue;
R_{H} is a mean rate of traffic through all higher priority queues together;
q_{H} is a log loss ratio of traffic through all higher priority queues together;
R is a mean rate of traffic through the lower priority queue and all higher priority queues together; and
q is a log loss ratio of traffic through the lower priority queue and all higher priority queues together.

40. The method of claim 36, further comprising providing plural servers in series in the node, treating the plural queues as if served by only one of the servers at a time, maintaining a set of the plural state variables at each server, and deciding to admit the new connection if the slowest server admits the new connection.
